(19) United States
(12) Patent Application Publication
(10) Pub. No.: US 2017/0061894 A1
(43) Pub. Date: Mar. 2, 2017

(54) IMAGE DISPLAY APPARATUS

(71) Applicant: CANON KABUSHIKI KAISHA, Tokyo (JP)

(72) Inventors: Takeshi Ikeda, Ebina-shi (JP); Yasuo Suzuki, Yokohama-shi (JP); Joji Kamahara, Tokyo (JP)

(21) Appl. No.: 15/244,366

(22) Filed: Aug. 23, 2016

(30) Foreign Application Priority Data
Aug. 26, 2015 (JP) 2015-166745
Mar. 25, 2016 (JP) 2016-062144

(51) Int. Cl. G09G 3/34; G09G 3/36

(52) U.S. Cl. CPC G09G 3/342; G09G 3/36; G09G 2320/0646; G09G 2320/0247; G09G 2320/066; G09G 2330/021

(57) ABSTRACT

An apparatus includes: a light-emitting unit having light-emitting areas; a display unit that modulates light from the light-emitting unit; an acquisition unit that acquires a brightness characteristic value for each divided area; a first acquisition unit that acquires information of a second dynamic range; a second acquisition unit that acquires information of a specific area; a detection unit that detects a correspondence divided area; and a control unit that performs individual control of emission brightness of each light-emitting area and correction of an input image data, so that display in a first dynamic range is performed in a non-correspondence divided area, and display in the second dynamic range is performed in the correspondence divided area.

### BACKGROUND OF THE INVENTION

Field of the Invention

The present invention relates to an image display apparatus.

Description of the Related Art

Opportunities to use image data having a wide dynamic range are increasing. Image data having a wide dynamic range is called “high dynamic range (HDR) image data”. For example, there is an imaging apparatus that can generate HDR image data by taking photographs. HDR image data is often used for work in non-broadcasting system, such as in image editing. The standard for HDR image data is, for example, “SMPTE ST 2084” advocated by Society of Motion Picture and Television Engineers (SMPTE).

When an image display apparatus performs display in a wide dynamic range (HDR display), it is demanded to consider the Perceptual Quantizer (PQ) curve, which is specified in the SMPTE ST 2084 standard. The PQ curve is a curve which is created based on the brightness difference which human eyes can recognize. The PQ curve is specified in a wide brightness range of 0.005 to 10000 cd/m².

Further, in such an image display apparatus as a liquid crystal display, local dimming processing may be performed (Japanese Patent Application Laid-Open No. 2002-99250). In local dimming processing, a light-emitting unit (backlight unit), which has a plurality of light-emitting areas corresponding to a plurality of divided areas constituting the area on the screen respectively, is used. In concrete terms, the emission brightness of each light-emitting area is individually controlled, and image data decompression processing is performed based on the emission brightness of each light-emitting area. Thereby the contrast of a display image (image displayed on screen) is improved. To perform the HDR display, higher brightness is demanded for a backlight unit. The contrast of the display image is further improved by increasing the upper limit value of the emission brightness of the backlight unit (light-emitting areas).

### SUMMARY OF THE INVENTION

In some cases where HDR display is performed, the emission brightness may be controlled to be very high in many light-emitting areas. This increases the power consumption of the image display apparatus. For example, at a location where image content such as a movie is filmed, the image display apparatus is sometimes powered by batteries and the captured images are displayed in HDR. In such a case, the image display apparatus may be unable to perform HDR display for a long time because of the increased power consumption mentioned above, and the image display apparatus may not be used for lengthy filming. If the image display apparatus is powered by an AC adapter, the image display apparatus can perform HDR display for a long time. However if the image is displayed at a very high brightness in many areas on screen, the eye fatigue of the user may intensify due to glare.

The present invention provides a technique to conserve the power consumption of the image display apparatus in a case where the HDR display is performed, and ease the eye fatigue of the user in a case where viewing the HDR display.

The present invention in its first aspect provides an image display apparatus comprising:

a light-emitting unit which has a plurality of light-emitting areas respectively corresponding to a plurality of divided areas constituting an area on a screen;

a display unit configured to display an image on the screen by modulating light from the light-emitting unit based on image data;

a characteristic value acquisition unit configured to acquire, for each of the plurality of divided areas, a brightness characteristic value of image data corresponding to the divided area, from input image data;

a first information acquisition unit configured to acquire range information indicating a second dynamic range, which is wider than a first dynamic range determined in advance;

a second information acquisition unit configured to acquire area information indicating a specific area, which is an image area where display is performed in the second dynamic range;

a detection unit configured to detect a correspondence divided area, which is a divided area corresponding to the specific area, from the plurality of divided areas based on the area information; and

a control unit configured to perform individual control of emission brightness of each light-emitting area and correction of the input image data, based on the brightness characteristic value of each divided area, the range information and the detection result of the correspondence divided area, so that display in the first dynamic range is performed in a non-correspondence divided area, which is a divided area other than the correspondence divided area, and display in the second dynamic range is performed in the correspondence divided area.

The present invention in its second aspect provides an image display system comprising an image output apparatus and an image display apparatus, wherein

the image output apparatus includes:
an image output unit configured to output target image data to be displayed to the image display apparatus;
a first information output unit configured to output range information indicating a second dynamic range, which is wider than a first dynamic range determined in advance, to the image display apparatus; and

a second information output unit configured to output area information indicating a specific area, which is an image area where display is performed in the second dynamic range, to the image display apparatus, and

the image display apparatus includes:
a light-emitting unit which has a plurality of light-emitting areas respectively corresponding to a plurality of divided areas constituting an area on a screen;
a display unit configured to display an image on the screen by modulating light from the light-emitting unit based on image data;
an image acquisition unit configured to acquire the target image data from the image output apparatus;
a characteristic value acquisition unit configured to acquire, for each of the plurality of divided areas, a brightness characteristic value of image data corresponding to the divided area, from the target image data;
a first information acquisition unit configured to acquire the range information from the image output apparatus;
a second information acquisition unit configured to acquire the area information from the image output apparatus;
a detection unit configured to detect a correspondence divided area, which is a divided area corresponding to the specific area, from the plurality of divided areas based on the area information; and
a control unit configured to perform individual control of emission brightness of each light-emitting area and correction of the target image data, based on the brightness characteristic value of each divided area, the range information and the detection result of the correspondence divided area, so that display in the first dynamic range is performed in a non-correspondence divided area, which is a divided area other than the correspondence divided area, and display in the second dynamic range is performed in the correspondence divided area.

The present invention in its third aspect provides a control method for an image display apparatus including a light-emitting unit which has a plurality of light-emitting areas respectively corresponding to a plurality of divided areas constituting an area on a screen, and a display unit configured to display an image on the screen by modulating light from the light-emitting unit based on image data, the control method comprising the steps of:

acquiring, for each of the plurality of divided areas, a brightness characteristic value of image data corresponding to the divided area, from input image data;

acquiring range information indicating a second dynamic range, which is wider than a first dynamic range determined in advance;

acquiring area information indicating a specific area, which is an image area where display is performed in the second dynamic range;

detecting a correspondence divided area, which is a divided area corresponding to the specific area, from the plurality of divided areas based on the area information; and

performing individual control of emission brightness of each light-emitting area and correction of the input image data, based on the brightness characteristic value of each divided area, the range information and the detection result of the correspondence divided area, so that display in the first dynamic range is performed in a non-correspondence divided area, which is a divided area other than the correspondence divided area, and display in the second dynamic range is performed in the correspondence divided area.

The present invention in its fourth aspect provides a non-transitory computer readable medium that stores a program, wherein

the program causes a computer to execute a control method for an image display apparatus including a light-emitting unit which has a plurality of light-emitting areas respectively corresponding to a plurality of divided areas constituting an area on a screen, and a display unit configured to display an image on the screen by modulating light from the light-emitting unit based on image data, and

the control method includes the steps of:

acquiring, for each of the plurality of divided areas, a brightness characteristic value of image data corresponding to the divided area, from input image data;

acquiring range information indicating a second dynamic range, which is wider than a first dynamic range determined in advance;

acquiring area information indicating a specific area, which is an image area where display is performed in the second dynamic range;

detecting a correspondence divided area, which is a divided area corresponding to the specific area, from the plurality of divided areas based on the area information; and

performing individual control of emission brightness of each light-emitting area and correction of the input image data, based on the brightness characteristic value of each divided area, the range information and the detection result of the correspondence divided area, so that display in the first dynamic range is performed in a non-correspondence divided area, which is a divided area other than the correspondence divided area, and display in the second dynamic range is performed in the correspondence divided area.

The present invention in its fifth aspect provides an image display apparatus comprising:

a light-emitting unit which has a plurality of light-emitting areas respectively corresponding to a plurality of divided areas constituting an area on a screen;

a display unit configured to display an image on the screen by modulating light from the light-emitting unit based on the image data;

a characteristic value acquisition unit configured to acquire, for each of the plurality of divided areas, a brightness characteristic value of image data corresponding to the divided area, from input image data;

an information acquisition unit configured to acquire range information indicating a second dynamic range, which is wider than a first dynamic range determined in advance;

a detection unit configured to detect, as a specific area, a divided area that includes a pixel having the second dynamic range, from the plurality of divided areas based on the brightness characteristic value of each divided area;

a combining unit configured to, so that the detection result of the specific area is displayed as a graphic image, combine graphic image data indicating the graphic image;

a user interface unit configured to accept an instruction from a user whether display in the second dynamic range is performed in the specific area, after the graphic image is displayed; and

a control unit configured to perform individual control of emission brightness of each light-emitting area and correction of the input image data, based on the brightness characteristic value of each divided area, the range information and the instruction from the user, so that display in the first dynamic range or the second dynamic range is performed in the specific area.

According to the present invention, power consumption of the image display apparatus can be conserved in a case where the HDR display is performed, and eye fatigue of the user in a case where viewing the HDR display can be eased.

Further features of the present invention will become apparent from the following description of exemplary embodiments with reference to the attached drawings.

### BRIEF DESCRIPTION OF THE DRAWINGS

FIG. 1A is a block diagram depicting an example of a functional configuration of an image display apparatus according to Example 1;

FIG. 1B is a block diagram depicting an example of a functional configuration of the image display apparatus according to Example 1;

FIGS. 2A and 2B show an example of target image data and brightness characteristic value according to Example 1;

FIGS. 3A to 3C show an example of an HDR area according to Example 1, and an HDR divided area detection result;

FIGS. 4A and 4B are graphs depicting an example of BL conversion information according to Example 1;

FIGS. 5A to 5C show an example of an HDR divided area detection result and emission brightness according to Example 1;

FIGS. 6A to 6C are graphs depicting an example of the conversation processing according to Example 1;

FIG. 7 shows an example of a viewer image according to Example 1;

FIG. 8A is a block diagram depicting an example of a functional configuration of an image display apparatus according to Example 2;

FIG. 8B is a block diagram depicting an example of a functional configuration of the image display apparatus according to Example 2;

FIG. 9 shows an example of corrected brightness according to Example 2;

FIG. 10A is a block diagram depicting an example of a functional configuration of an image display apparatus according to Example 3;

FIG. 10B is a block diagram depicting an example of a functional configuration of the image display apparatus according to Example 3;

FIG. 11 shows an example of estimated brightness distribution according to Example 3;

FIG. 12 shows an example of a combined image according to Example 3;

FIG. 13 is a block diagram depicting an example of a functional configuration of an image display apparatus according to Example 4;

FIG. 14 is a block diagram depicting an example of a functional configuration of the image display apparatus according to Example 5;

FIGS. 15A and 15B show an example of target brightness according to Example 5; and

FIG. 16 shows an example of a display image according to Example 5.

### DESCRIPTION OF THE EMBODIMENTS

### Example 1

An image display apparatus according to Example 1 of the present invention will now be described. Description of a case where the image display apparatus according to this example is a transmission type liquid crystal display apparatus follows, but the image display apparatus according to this example is not limited to the transmission type liquid crystal display apparatus. The image display apparatus according to this example can be any image display apparatus constituted by a light-emitting unit and a display unit configured to display an image on a screen by modulating the light from the light-emitting unit based on the image data. For example, the image display apparatus according to this example may be a reflection type liquid crystal display apparatus. The image display apparatus according to this example may be a micro electro mechanical system (MEMS) shutter type display apparatus that uses MEMS shutters instead of liquid crystal elements.

The light-emitting unit of the image display apparatus according to this example has a plurality of light-emitting areas corresponding to a plurality of divided areas constituting an area on the screen respectively. The emission brightness can be individually controlled for each of the plurality of light-emitting areas. By performing individual control of the emission brightness of each light-emitting area and correction of input image data (image data input to the image display apparatus), the image display apparatus according to this example can perform a display in various dynamic ranges in each of the plurality of divided areas.

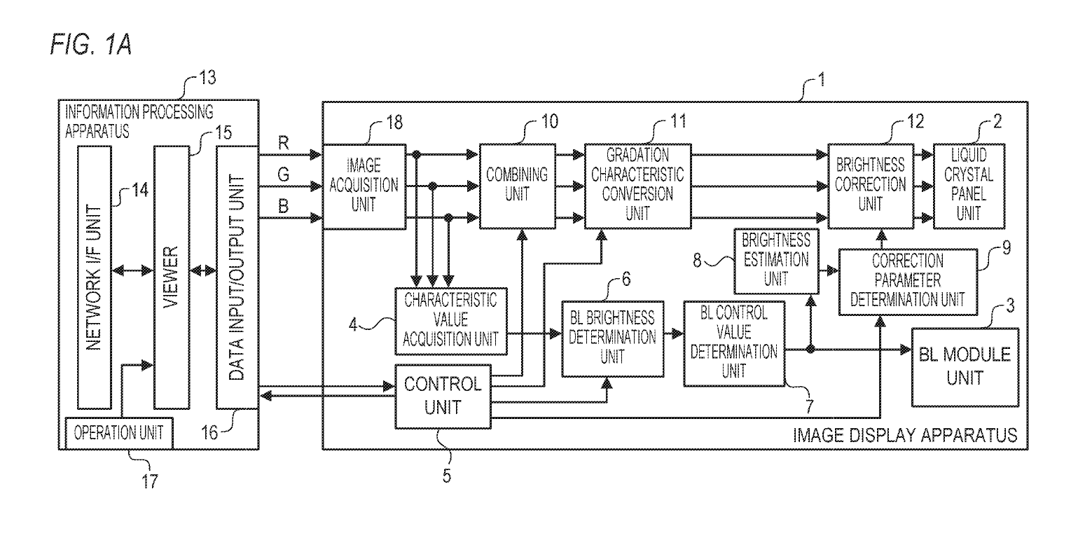

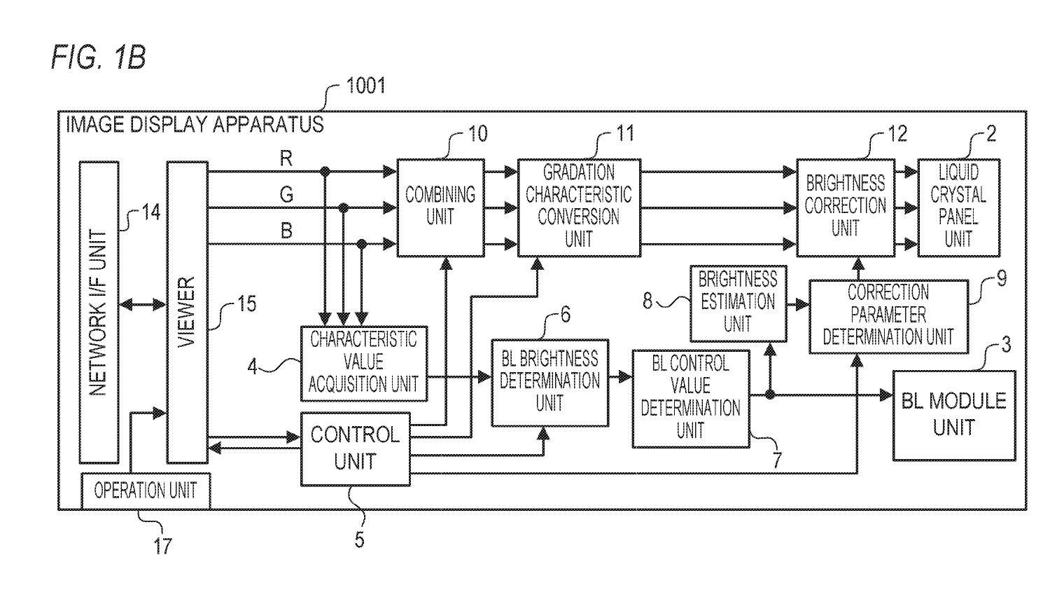

FIGS. 1A and 1B are block diagrams depicting examples of the functional configuration of the image display apparatus according to this example. In FIG. 1A, the image display apparatus 1 according to this example is used in an image display system that includes an information processing apparatus 13. For the information processing apparatus 13, which is an external apparatus of the image display apparatus 1, a workstation, a personal computer, a smartphone or the like can be used.

In FIG. 1A, a viewer application (viewer) which is installed in the information processing apparatus 13 is linked with the image display apparatus 1, whereby the range information and area information are notified (input) from the information processing apparatus 13 to the image display apparatus 1. The range information indicates a dynamic range (HDR: second dynamic range) that is wider than a standard dynamic range (SDR: first dynamic range) determined in advance. The area information indicates an image area (HDR area: specific area) in which display in the HDR is performed. HDR is a dynamic range which the user requests for the HDR area. The HDR area is an image area in which the user requests to display images in HDR (HDR display).

In FIG. 1A, the image display apparatus 1 determines a divided area corresponding to the HDR area as an HDR divided area (correspondence divided area). Then the image display apparatus 1 performs the individual control of the emission brightness of each light-emitting area and correction of the input image data, so that the HDR display is performed in the HDR divided area and the SDR display is performed in a non-HDR divided area (non-correspondence divided area). The non-HDR divided area is a divided area other than the HDR divided area (other than the correspondence divided area), and the SDR display is displayed in the SDR. Thereby the areas where the HDR display is performed are limited to the HDR areas, hence the power consumption of the image display apparatus during HDR display can be reduced and the eye fatigue of the user in a case of viewing the HDR display can be eased.

Further, in FIG. 1A, the image display apparatus 1 notifies information on the areas on screen where the HDR display is performed to the user. Thereby the user can easily recognize: the areas where the HDR display is performed; and the other areas. As a result, the convenience for checking the image quality of the image displayed in the areas where the HDR display is performed and the image quality of the image displayed in the other areas can be improved.

In FIG. 1B, an image display apparatus 1001 according to this example includes the function of the information processing apparatus 13 in FIG. 1A. Therefore in FIG. 1B, the image display apparatus 1001 acquires the range information and area information according to the user operation performed for the image display apparatus 1001. For example, the image display apparatus 1001 acquires the range information according to the user operation to select an HDR, or acquires the area information according to the user operation to select an HDR area. The image display apparatus 1001 may acquire at least one of the range information and area information according to the user operation to set the operation mode of the image display apparatus 1001. For the input device to accept the user operation for the image display apparatus 1001, a keyboard, a mouse, a special input device having a jog dial dedicated to image editing, and a touch panel disposed on the screen of the image display apparatus 1001, for example, can be used.

In FIG. 1A, it is unnecessary to input at least one of the range information and area information from the information processing apparatus 13 (external apparatus) to the image display apparatus 1. For example, the image display apparatus 1 may acquire at least one of the range information and the area information according to the user operation performed for the image display apparatus 1.

The image display system in FIG. 1A will now be described in detail. The processing performed by the image display apparatus 1001 in FIG. 1B is the same as the processing performed by the image display system in FIG. 1A, hence detailed description of the image display apparatus 1001 in FIG. 1B will be omitted.

The image display apparatus 1 will be described first. The image display apparatus 1 includes a liquid crystal panel unit 2, a BL module unit 3, a characteristic value acquisition unit 4, a control unit 5, a BL brightness determination unit 6, a BL control value determination unit 7, a brightness estimation unit 8, a correction parameter determination unit 9, a combining unit 10, a gradation characteristic conversion unit 11, a brightness correction unit 12, and an image acquisition unit 18.

The liquid crystal panel unit 2 displays an image on the screen by transmitting (modulating) the light from the BL module unit 3 based on the image data. The liquid crystal panel unit 2 includes a liquid crystal panel constituted by a plurality of liquid crystal elements, a liquid crystal driver for driving each liquid crystal element, and a control substrate for controlling the processing of the liquid crystal driver. The control substrate controls the processing of the liquid crystal driver based on the image data, which is input to the liquid crystal panel unit 2. Thereby the transmittance of each liquid crystal element is controlled to a value corresponding to the image data which was input to the liquid crystal panel unit 2. The light from the BL module unit 3 transmits through each liquid crystal element at a transmittance corresponding to the image data which was input to the liquid crystal panel unit 2. Then an image based on the image data which was input to the liquid crystal panel unit 2 is displayed on the screen.

The BL module unit 3 is a light-emitting unit that has a plurality of light-emitting areas. The BL module unit 3 irradiates light to a rear face of the liquid crystal panel unit 2 (liquid crystal panel). Each light-emitting area emits light at the emission brightness corresponding to the BL control value determined by the BL control value determination unit 7. Each light-emitting area has one or more light sources. The BL module unit 3 includes a plurality of light sources, a driving circuit for driving each light source, and an optical unit for diffusing light from each light source. In this example, the plurality of divided areas are arrayed in a matrix, and the plurality of light-emitting areas are also arrayed in a matrix. In concrete terms, an area on the screen is constituted by 10 divided areas in the horizontal direction×6 divided areas in the vertical direction, and the BL module unit 3 has 10 light-emitting areas in the horizontal direction×6 light-emitting areas in the vertical direction. For each light source, a light-emitting diode (LED), an organic EL element or a cold cathode tube, for example, can be used.

In this example, an area on the screen is constituted by 1920 pixels in the horizontal direction×1080 pixels in the vertical direction. And in this example, an area on the screen is constituted by a plurality of divided areas of which sizes are the same. As mentioned above, in this example, an area on the screen is constitute by 10 divided areas in the horizontal direction×6 divided areas in the vertical direction. This means that each divided area is constituted by 192 pixels in the horizontal direction×180 pixels in the vertical direction.

The size of the screen, the number of divided areas, the arrangement of the divided areas, the sizes of the divided areas, the number of the light-emitting areas, the arrangement of the light-emitting areas and the sizes of the light-emitting areas are not especially limited. The number of pixels constituting the area on the screen may be more or less than 1920 pixels in the horizontal direction×1080 pixels in the vertical direction. The number of divided areas may be more or less than 60. The plurality of divided areas may be disposed in a staggered manner. The sizes of the plurality of divided areas may be different from one another. The same is true for the light-emitting areas.

The image acquisition unit 18 acquires input image data (target image data to be displayed) from the information processing apparatus 13. The image acquisition unit 18 outputs the acquired target image data to the characteristic value acquisition unit 4 and the combining unit 10. In this example, image data having 12-bit RGB values (12 bits of R value, 12 bits of G value, 12 bits of B value) as the pixel values is acquired as the target image data. The data format of the target image data (e.g. number of bits of pixel value, type of pixel value) is not especially limited. For example, image data having 12-bit YDxDz values (12 bits of Y value, 12 bits of Dx value, 12 bits of Dz value) as the pixel values may be acquired as the target image data. Image data having 10-bit YCbCr values (10 bits of Y value, 10 bits of Cb value, 10 bits of Cr value) as the pixel values may be acquired as the target image data.

The characteristic value acquisition unit 4 acquires, for each of the plurality of divided areas, a brightness characteristic value of the image data corresponding to the divided area from the target image data. The characteristic value acquisition unit 4 outputs the brightness characteristic value of each divided area to the BL brightness determination unit 6. The brightness characteristic value is a characteristic value related to brightness. In this example, the maximum gradation value, which is a maximum value of the gradation values (R value, G value, B value), is acquired as the brightness characteristic value. For example, if the maximum value of the R value is 50, the maximum value of the G value is 1000 and the maximum value of the B value is 100, then 1000 is acquired as the brightness characteristic value.

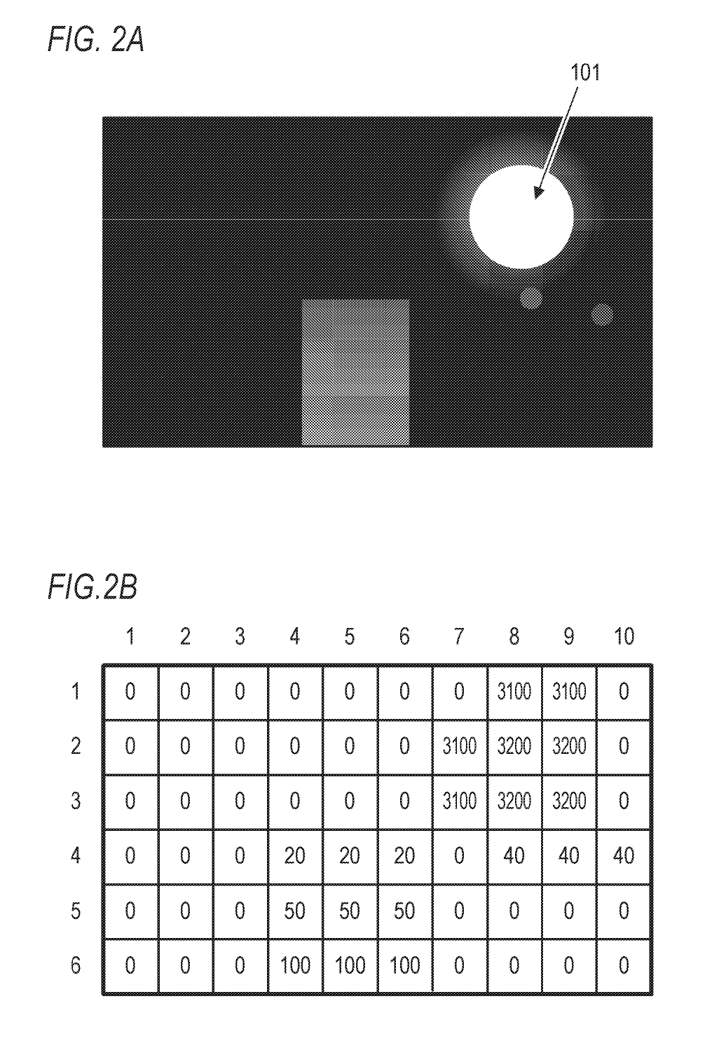

FIG. 2A shows an example of the target image data, and FIG. 2B shows the brightness characteristic value (maximum gradation values) acquired from the target image data in FIG. 2A. In FIG. 2B, the numbers 1 to 10 in the horizontal direction indicate the horizontal positions of the divided areas (positions in the horizontal direction), and the numbers 1 to 6 in the vertical direction indicate the vertical positions of the divided areas (positions in the vertical direction). As mentioned above, the gradation value of the target image data is the 12-bit value (0 to 4095). In FIG. 2A, an object 101 in the upper part of the screen is an object displayed at high brightness. As shown in FIG. 2B, the brightness characteristic value (maximum gradation value) of the divided area, in which at least a part of the object 101 is displayed, is 3100 or 3200.

The brightness characteristic value is not limited to the maximum gradation value. For example, a representative value of the gradation value (minimum value, mean value, mode value, median value) may be acquired as the brightness characteristic value. The histogram of the gradation value may be acquired as the brightness characteristic value. The number of pixels having a gradation value greater than a threshold (pixel in a bright area) may be acquired as the brightness characteristic value. Alternatively, the number of pixels having a gradation value smaller than a threshold (pixel in a dark area) may be acquired as the brightness characteristic value. The brightness characteristic value may be acquired using the brightness value (Y value) as the gradation value.

The control unit 5 acquires the range information from the information processing apparatus 13 (first information acquisition). The control unit 5 also acquires the area information from the information processing apparatus 13 (second information acquisition). Then the control unit 5 detects the HDR divided areas from the plurality of divided areas based on the area information. In this example, a divided area, in which at least a part of the HDR area is displayed, is detected as the HDR divided area. The control unit 5 outputs the HDR divided area detection result to the BL brightness determination unit 6, the correction parameter determination unit 9, the combining unit 10, and the gradation characteristic conversion unit 11. The control unit 5 also outputs the range information to the BL brightness determination unit 6, the correction parameter determination unit 9, and the gradation characteristic conversion unit 11.

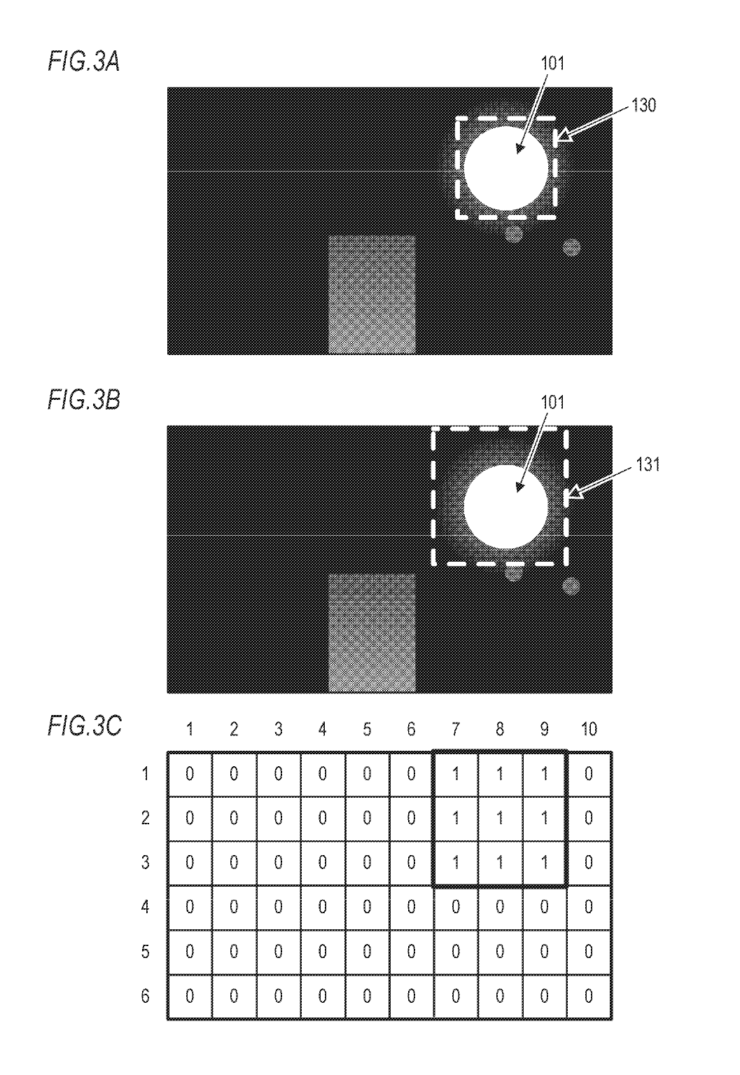

FIG. 3A shows an example of the HDR area. In FIG. 3A, the area enclosed by the broken line 130 is the HDR area. In FIG. 3A, the area including the object 101 is specified as the HDR area. The image display apparatus 1 cannot perform both the SDR display and the HDR display in one divided area. However, in some cases, the HDR area may be specified without considering the divided areas. This means that a contour of an HDR area does not always correspond to the boundaries of the plurality of divided areas. Therefore the control unit 5 detects a divided area which includes at least a part of the HDR area as an HDR divided area.

FIGS. 3B and 3C show the HDR divided area detection result in a case where the area enclosed by the broken line 130 in FIG. 3A is the HDR area. In FIG. 3B, the area enclosed by the broken line 131 indicates an area constituted by a plurality of HDR divided areas. In FIG. 3C, a divided area with a “1” is an HDR divided area, and a divided area with a “0” is a non-HDR divided area. The control unit 5 outputs information associating “0” or “1” to each of the plurality of divided areas, for example, as the HDR divided area detection result.

The HDR divided area detection method is not limited to the above mentioned method. For example, a divided area which includes at least a part of the HDR area and divided areas adjacent to this divided area may be detected as the HDR divided area. Only a divided area which includes at least a part of the HDR area may be detected as the HDR divided area. A divided area which includes only at least a part of the HDR area and divided areas adjacent to this divided area may be detected as the HDR divided area.

The BL brightness determination unit 6 and the BL control value determination unit 7 perform individual control for the emission brightness of each light-emitting area. Then the brightness estimation unit 8, the correction parameter determination unit 9, the gradation characteristic conversion unit 11, and the brightness correction unit 12 correct the target image data. In this example, the individual control for the emission brightness of each light-emitting area and the correction of the target image data are performed so that the SDR display is performed in the non-HDR divided areas and the HDR display is performed in the HDR divided areas. For this processing, the brightness characteristic value of each divided area, the range information and the HDR divided area detection result are used. As long as the brightness characteristic value of each divided area, the range information and the HDR divided area detection result are used, any method may be used to perform the individual control for the emission brightness of each light-emitting area and the correction of the target image data. In this example, the individual control for the emission brightness of each light-emitting area is performed based on the brightness characteristic value of each divided area, the range information and the HDR divided area detection result. Then the target image data is corrected based on the range information, the HDR divided area detection result, and the emission brightness of each light-emitting area.

The BL brightness determination unit 6 determines the emission brightness (target brightness) of each light-emitting area based on the brightness characteristic value of each divided area, the range information and the HDR divided area detection result. The BL brightness determination unit 6 outputs the information indicating the emission brightness of each light-emitting area to the BL control value determination unit 7. In this example, for each of the plurality of light-emitting areas, the BL brightness determination unit 6 determines the emission brightness of the light-emitting area based on the brightness characteristic value of the divided area corresponding to the light-emitting area. To determine the emission brightness, a first brightness range corresponding to the SDR is used as the range of the emission brightness of the light-emitting area corresponding to the non-HDR divided area, and a second brightness range corresponding to the HDR is used as the range of the emission brightness of the light-emitting area corresponding to the HDR divided area. For example, for each of the plurality of light-emitting areas, the BL brightness determination unit 6 sets or generates information indicating the correspondence of the brightness characteristic value and the emission brightness (BL conversion information: lookup table; function or the like) based on the range information and the HDR divided area detection result. Then for each of the plurality of light-emitting areas, the BL brightness determination unit 6 determines the emission brightness based on the BL conversion information and the brightness characteristic value. In concrete terms, the BL brightness determination unit 6 determines the emission brightness corresponding to the brightness characteristic value of a light-emitting area (divided area) in the correspondence indicated by the BL conversion information, as the emission brightness of this light-emitting area.

In this example, a case where the ratio of the first brightness range and the second brightness range matches the ratio of the HDR and the SDR will be described. Further, in this example, a case where the minimum brightness of a first brightness range matches the minimum brightness of a second brightness range, and the minimum brightness of the SDR matches the minimum brightness of the HDR will be described. In concrete terms, a case where the minimum brightness of the first brightness range, the minimum brightness of the second brightness range, the minimum brightness of the SDR and the minimum brightness of the HDR matches the brightness corresponding to the lower limit value of the gradation of the image data will be described. However the ratio of the first brightness range and the second brightness range may be different from the ratio of the HDR and the SDR. The minimum brightness of the first brightness range may be different from the minimum brightness of the second brightness range. The minimum brightness of the SDR may be different from the minimum brightness of the HDR. Further, at least one of the minimum brightness of the first brightness range, the minimum brightness of the second brightness range, the minimum brightness of the SDR and the minimum brightness of the HDR may be different from the brightness corresponding to the lower limit value of the gradation value of the image data.

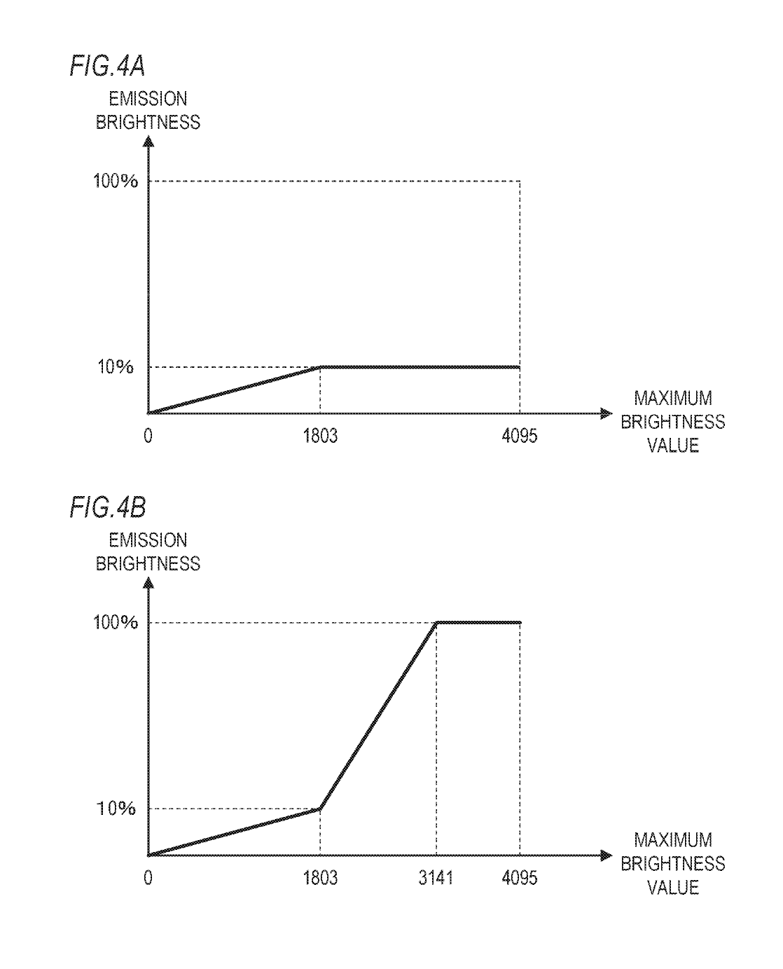

FIGS. 4A and 4B show an example of the correspondence indicated by the BL conversion information. The abscissas of FIGS. 4A and 4B indicate the maximum gradation value, which is the brightness characteristic value, and the ordinates of FIGS. 4A and 4B indicate the emission brightness. 0% of the emission brightness corresponds to the state where the light-emitting area does not turn ON, and 100% of the emission brightness corresponds to the state where the light-emitting area turns ON at the upper limit emission brightness. The emission brightness of the light-emitting area corresponding to the non-HDR divided area is determined according to the correspondence shown in FIG. 4A. The emission brightness of the light-emitting area corresponding to the HDR divided area is determined according to the correspondence shown in FIG. 4B.

In this example, it is assumed that the range of the SDR is 0 to 200 cd/m², and the range of the HDR is 0 to 2000 cd/m². The gradation value corresponding to the maximum brightness of the SDR is 1803, and the gradation value corresponding to the maximum brightness of the HDR is 3141, as described next in detail. In FIG. 4A, the range emission brightness (first brightness range) is 0% to 10%. In FIG. 4B, the range of the emission brightness (second brightness range) is 0% to 100%. In this way, the ratio of the first brightness range and the second brightness range (10/100) matches the ratio of the SDR and the HDR (200/2000).

In FIGS. 4A and 4B, the emission brightness, which increases from the minimum brightness in the first brightness range to the maximum brightness in the first brightness range as the maximum gradation value increases, correlates with the maximum gradation value, which is not more than the gradation value corresponding to the maximum brightness of the SDR. In concrete terms, the maximum gradation value, which is not more than 1803, correlates with the emission brightness which increases from 0% to 10% as the maximum gradation value increases. Further, in FIG. 4A, an emission brightness, which is identical to the maximum brightness in the first brightness range, correlates with the maximum gradation value, which is more than the gradation value corresponding to the maximum brightness of the SDR. In concrete terms, a 10% emission brightness correlates with the maximum gradation value which is more than 1803.

In FIG. 4B, the emission brightness, which increases as the maximum gradation value increases, correlates with the maximum gradation value, which is not less than the gradation value corresponding to the maximum brightness of the SDR, and not more than the gradation value corresponding to the maximum brightness of the HDR. In concrete terms, the emission brightness, which increases from the maximum brightness in the first brightness range to the maximum brightness in the second brightness range as the maximum gradation value increases, correlates with the maximum gradation value which is not less than the gradation value corresponding to the maximum brightness of the SDR and not more than the gradation value corresponding to the maximum brightness of the HDR. More specifically, the emission brightness, which increases from 10% to 100% as the maximum gradation value increases, correlates with the maximum gradation value which is not less than 1083 and not more than 3141. Further in FIG. 4B, the emission brightness, which is identical to the maximum brightness in the second brightness range, correlates with the maximum gradation value which is more than the gradation value corresponding to the maximum brightness of the HDR. In concrete terms, a 100% emission brightness correlates with the maximum gradation value which is more than 4095.

As the correspondence of the maximum gradation value and the emission brightness, FIGS. 4A and 4B show the correspondences connecting the linear characteristics, but the correspondence of the maximum gradation value and the emission brightness is not limited to the correspondences shown in FIGS. 4A and 4B. For example, the emission brightness may exponentially increase as the maximum gradation value increases, at least in a part of the range of the maximum gradation value. The correspondence of the maximum gradation value and the emission brightness may be determined considering the correspondence of brightness and gradation value in the dynamic range (correspondence of display brightness (brightness of the screen) and the gradation value).

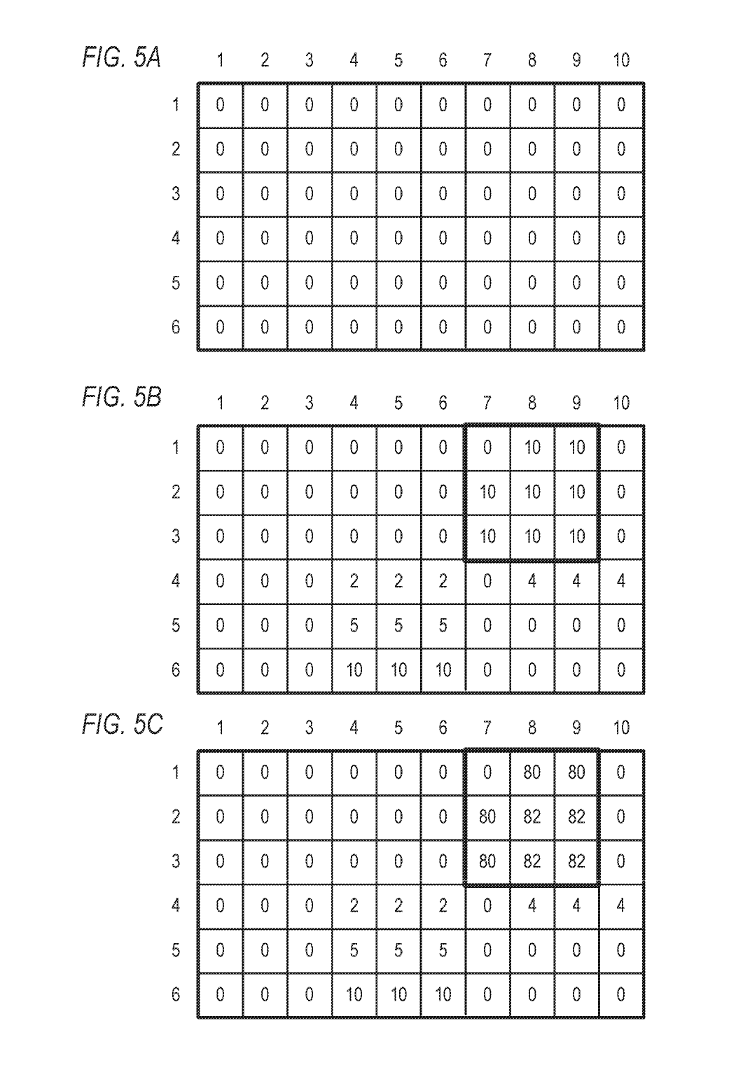

A case where the maximum gradation value in FIG. 2B is acquired for the maximum gradation value of each divided area will be described. If an HDR area does not exist, all divided areas are set as the non-HDR divided areas, as shown in FIG. 5A. In FIG. 5A, a divided area with a “0” is a non-HDR divided area. Therefore in this case, the emission brightness in all the light-emitting areas is determined according to the correspondence in FIG. 4A. As a result, the emission brightness shown in FIG. 5B is acquired as the emission brightness of each light-emitting area.

If the result shown in FIG. 3C is acquired as the HDR divided area detection result, the light-emitting areas corresponding to the divided areas enclosed by the bold line in FIG. 3C is determined according to the correspondence in FIG. 4B. In concrete terms, the emission brightness of each of the nine light-emitting areas of which (horizontal position, vertical position)=(7, 1) to (7, 3), (8, 1) to (8, 3) and (9, 1) to (9, 3) is determined according to the correspondence in FIG. 4B. Then the emission brightness of each of the remaining light-emitting areas is determined according to the correspondence in FIG. 4A. As a result, the emission brightness shown in FIG. 5C is acquired as the emission brightness of each light-emitting area.

The BL control value determination unit 7 converts the emission brightness (target brightness) of each light-emitting area determined by the BL brightness determination unit 6 into a BL control value. The BL control value determination unit 7 outputs the BL control value of each light-emitting area to the BL module unit 3. Thereby each light-emitting area emits light at the emission brightness determined by the BL brightness determination unit 6. Furthermore, the BL control value determination unit 7 outputs the BL control value of each light-emitting area to the brightness estimation unit 8 as well. If the emission brightness of the light source of each light-emitting area is controlled by the pulse-width modulation system, a value indicating the pulse width is used as the BL control value. If the emission brightness of the light source of each light-emitting area is controlled by the pulse-amplitude modulation system, the value indicating the pulse amplitude is used as the BL control value. If the emission brightness is controlled by a system of modulating both the pulse width and the pulse amplitude, then the values indicating the pulse width and the pulse amplitude are used as the BL control value.

In order to display the first graphic image in addition to the image based on the corrected target image data, the combining unit 10 combines the first graphic image data representing the first graphic image based on the HDR divided area detection result (first combination). Thereby combined image data, where the first graphic image data is combined with the target image data, is generated. The first graphic image is a graphic image indicating an area on the screen where a display is performed in the HDR (HDR display area). For example, the first graphic image is an image enclosed by the broken line 131 in FIG. 3B (image in the rectangular frame). The information on the HDR display area is notified to the user by the first graphic image being displayed. In other words, the user can recognize the HDR display area by viewing the first graphic image that is displayed. The combining unit 10 outputs the combined image data to the gradation characteristic conversion unit 11. The combining unit 10 may be omitted.

The gradation characteristic conversion unit 11 performs the conversion processing to convert the gradation characteristic of the image data based on the range information and the HDR divided area detection result. By the conversion processing, the gradation characteristic of the image data corresponding to the non-HDR divided area is converted so that the range of the display brightness corresponding to the range of the gradation value of the image data matches with the SDR. Further, by the conversion processing, the gradation characteristic of the image data corresponding to the HDR divided area is converted so that the range of the display brightness corresponding to the range of the gradation value of the image data matches the HDR. In this example, conversion processing is performed on the combined image data. Thereby the converted image data is generated. The gradation characteristic conversion unit 11 outputs the converted image data to the brightness correction unit 12.

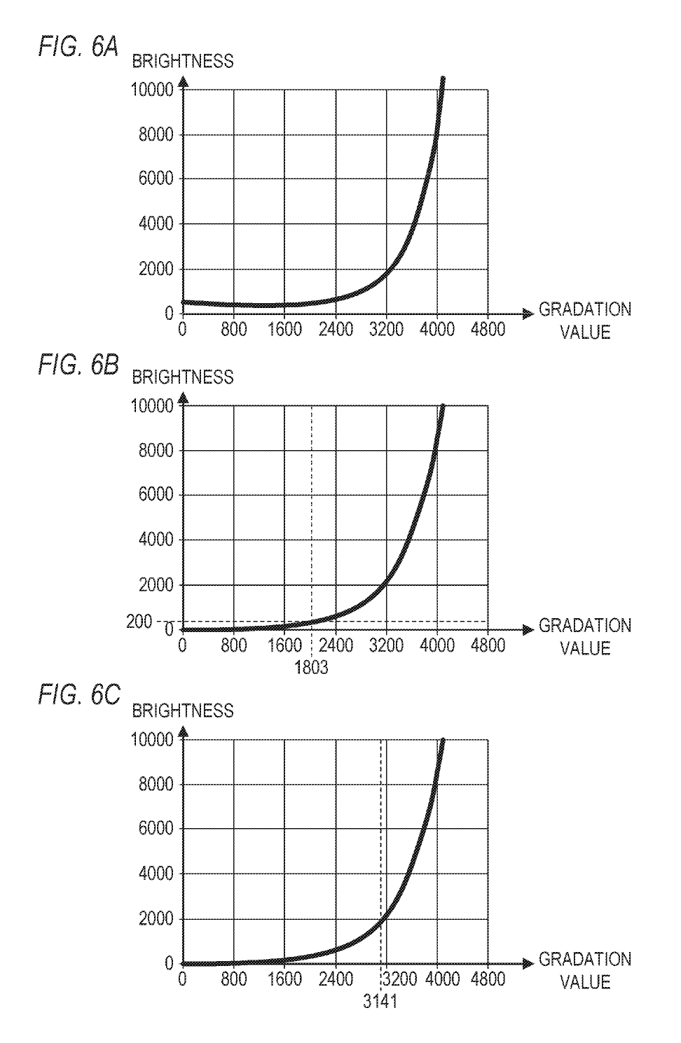

An example of the conversion processing will be described with reference to FIGS. 6A to 6C. The ordinates of FIGS. 6A to 6C indicate the brightness, and the abscissas of FIGS. 6A to 6C indicate the gradation value. FIG. 6A shows the correspondence between the gradation value and brightness (display brightness). The correspondence between the gradation value and brightness is not limited to the correspondence in FIG. 6A.

In this example, the maximum brightness of the SDR is 200 cd/m². As shown in FIG. 6B, the gradation value corresponding to 200 cd/m² is 1803. In the conversion processing, if the gradation value of the image data corresponding to the non-HDR divided area is more than 1803, this gradation value is converted to 1803. In other words, the upper limit value of the gradation value of the image data corresponding to the non-HDR divided area is limited to 1803. Then the range of the gradation value of the image data corresponding to the non-HDR divided area is expanded from the 0 to 1803 range to the original range (0 to 4095).

Further, in this example, the maximum brightness of the HDR is 2000 cd/m². As shown in FIG. 6C, the gradation value corresponding to 2000 cd/m² is 3141. In the conversion processing, if the gradation value of the image data corresponding to the HDR divided area is more than 3141, this gradation value is converted to 3141. In other words, the upper limit value of the gradation value of the image data corresponding to the HDR divided area is limited to 3141. Then the range of the gradation value of the image data corresponding to the HDR divided area is expanded from the 0 to 3141 range to the original range (0 to 4095).

The brightness estimation unit 8, the correction parameter determination unit 9, and the brightness correction unit 12 perform the correction processing to correct the gradation values of the image data based on the range information, the HDR divided area detection result, and the emission brightness of each light-emitting area. In the correction processing, the gradation value is corrected so that the display at brightness that is identical to the brightness in the case where the irradiation brightness matches the maximum brightness of the SDR is performed in the non-HDR divided area, and the display at brightness that is identical to the brightness in the case where the irradiation brightness matches the maximum brightness of the HDR is performed in the HDR divided area. The irradiation brightness is the brightness of light emitted from the BL module unit 3 to the liquid crystal panel unit 2.

The brightness estimation unit 8 estimates the irradiation brightness based on the emission brightness (BL control value) of each light-emitting area. The brightness estimation unit 8 outputs the irradiation brightness estimation result to the correction parameter determination unit 9. In this example, an attenuation coefficient, which indicates the attenuation of light in a case where the light emitted from each light-emitting area diffuses, is stored in memory (not illustrated) in advance. The brightness estimation unit 8 performs processing for multiplying the emission brightness (BL control value) by the attenuation coefficient corresponding to the position within the screen (the target estimation position for which irradiation brightness is estimated) for each light-emitting area. Then the brightness estimation unit 8 calculates the total of the multiplication result of each light-emitting area as the irradiation brightness. The irradiation brightness may be estimated by the above method for all the position within the screen, but in this case, the computation volume becomes enormous. Therefore in this example, the irradiation brightness is estimated by the above method only for some of the positions within the screen. In concrete terms, the center position of each divided area is used as an estimation position.

The attenuation coefficient may be appropriately changed depending on the deterioration state of the light source, the internal temperature of the image display apparatus 1, the external temperature of the image display apparatus 1, the user operation and the like. A position that is different from the center position of each divided area may be used as an estimation position. The estimation method for the irradiation brightness is not especially limited. For example, the image display apparatus 1 may include a photosensor to detect light from the BL module unit 3. And the irradiation brightness may be estimated based on the detection result by the photosensor.

The correction parameter determination unit 9 determines, for each position within the screen, a correction parameter to correct image data corresponding to this position. The correction parameter determination unit 9 determines a correction parameter, to suppress a change in the display brightness due to a change in the irradiation brightness from the maximum brightness of the SDR, for a position within the non-HDR divided area. Further, the correction parameter determination unit 9 determines a correction parameter, to suppress a change in the display brightness due to a change in the irradiation brightness of the HDR, for a position within the HDR divided area. The correction parameter determination unit 9 outputs a correction parameter at each position to the brightness correction unit 12.

The correction parameter determination unit 9 determines the correction parameter for the estimation position, based on the irradiation brightness at the estimation position, the HDR divided area detection result, and the range information. Here a case where the correspondence between the gradation value and the brightness is expressed by a gamma curve of gamma value G is considered. In this case, the correction coefficient, by which the gradation value is multiplied, can be determined as a correction parameter using the following Expression 1. In Expression 1, Lpn denotes the estimated irradiation brightness, Lt denotes the maximum brightness in the dynamic range, and Ppn denotes the correction coefficient. To calculate the correction coefficient Ppn at the estimation position in the non-HDR divided area, the maximum brightness of the SDR is used as the maximum brightness Lt. To calculate the correction coefficient Ppn at the estimation position in the HDR divided area, the maximum brightness of the HDR is used as the maximum brightness Lt.

Ppn=(Lt/Lpn)^{1/G} (Expression 1)

The correction parameter determination unit 9 calculates the correction parameter for each position other than the estimation positions by the interpolation processing using the correction parameters of the estimated positions.

The irradiation brightness at each position other than the estimated positions may be calculated by the interpolation processing using the irradiation brightness at the estimated positions, and the correction parameter may be calculated for all the positions by the same method. The correction parameter determination method is not especially limited. For the correction parameter determination method, various prior arts to suppress a change in the display brightness due to a change in the irradiation brightness may be used.

The brightness correction unit 12 corrects each gradation value of the converted image data using the correction parameter determined by the correction parameter determination unit 9. Thereby the corrected image data is generated. The brightness correction unit 12 outputs the corrected image data to the liquid crystal panel unit 2.

The information processing apparatus 13 will be described next. The information processing apparatus 13 includes a network I/F unit 14, a viewer 15, a data input/output unit 16, and an operation unit 17.

The operation unit 17 accepts user operation input to the information processing apparatus 13. For the operation unit 17, a keyboard, a mouse, a special input device having a jog dial dedicated to image editing and the like can be used. The user operation is executed using a GUI image (e.g. menu image) displayed on the image display apparatus 1, for example.

The network I/F unit 14 is connected to a network (not illustrated). The network I/F unit 14 acquires editing image data from a server (not illustrated) via a network, and outputs the acquired editing image data to the viewer 15. The editing image data is an editing target. For example, an instruction to acquire editing image data is sent from the viewer 15 to the network I/F unit 14 according to the user operation to the information processing apparatus 13, and the network I/F unit 14 acquires the editing image data from the network according to the instruction from the viewer 15. The user operation to the information processing apparatus 13 is, for example, a user operation to select the editing image data from a plurality of image data. The editing image data acquisition method is not limited to the above mentioned method. For example, the image data may be read, as editing image data, from a storage device installed in the information processing apparatus 13. The storage device may or may not be detachable from the information processing apparatus 13.

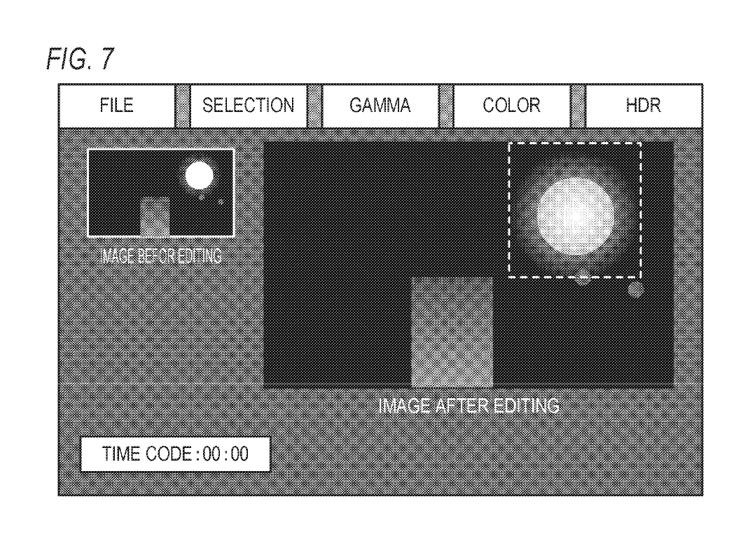

The viewer 15 generates viewer image data (target image data) representing the viewer image, and outputs the viewer image data to the data input/output unit 16. In the viewer image, an image before editing, a GUI image for editing (command image), a time code, an edited image and the like are arranged. FIG. 7 shows an example of the viewer image. When the user operation is executed using the GUI image in FIG. 7, the viewer 15 acquires a signal corresponding to the user operation from the operation unit 17, and executes the processing according to the acquired signal. Thereby selection of a target image data, a change of the colors, a change of the gamma values, a setting of an HDR, a setting of the HDR area, a saving of an edited image or the like is implemented. The target image data is not limited to the viewer image data. As shown in FIG. 2A, the GUI image and the time code may be omitted from the image represented by the target image data. In FIG. 7, the broken line indicated in the edited images indicates the HDR area. When the HDR and HDR area are set, the viewer 15 outputs the range information and area information to the data input/output unit 16.

The data input/output unit 16 outputs the viewer image data (target image data) to the image display apparatus 1 (image output). The data input/output unit 16 outputs the range information to the image display apparatus 1 (first information output). Then the data input/output unit 16 outputs the area information to the image display apparatus 1 (second information output). The range information and area information may be output as the meta data of the image data, or may be output as data that is separate from the image data. The data input/output unit 16 can acquire various information from the image display apparatus 1 (control unit 5). For example, the data input/output unit 16 can acquire such information as the position, size and number of light-emitting areas of the image display apparatus 1 from the image display apparatus 1. The transmission method for the range information, area information and information on the image display apparatus 1 or the like is not especially limited. If a transmission system is used based on a display port standard, this information can be transmitted using an AUX channel specified by the display port standard. This information may be transferred using a Universal Serial Bus (USB) or the like.

As described above, according to this example, the area where the HDR display is performed is limited to the HDR divided areas, hence power consumption of the image display apparatus during the HDR display can be reduced, and the eye fatigue of the user in a case of viewing the HDR display can be eased. Further, information on the areas on the screen where the HDR display is performed can be notified to the user. Thereby the user can easily recognize: the areas where the HDR display is performed; and the other areas. As a result, the convenience of viewing the image quality of the display image in the area where the HDR display is performed and the image quality of the display image in the other areas can be improved.

In this example, a case where the HDR area is a rectangular-shaped area was described, but the shape of the HDR area is not limited to a rectangle. A concave portion or a curved portion may exist in a part of a contour of the HDR area. Further, in this example, a case where the area information indicates one area (the HDR area) was described, but the area information may indicate a plurality of areas. In this case, the dynamic range may be different among a plurality of areas indicated by the area information.

### Example 2

An image display apparatus according to Example 2 of the present invention will now be described. In the following, the configuration and processing that are different from Example 1 will be described in detail, and description of the configuration and processing that are the same as Example 1 will be omitted.

In Example 1, the emission brightness of each light-emitting area may become considerably different among the divided areas. For example, the emission brightness of each light-emitting area may become considerably different between an HDR divided area and a non-HDR divided area. This major difference causes the generation of a halo, the generation of flickering in a moving image display, and the like. Therefore in this example, spatial low-pass filter processing (spatial LPF processing: smoothing processing) is performed to smooth the distribution of the emission brightness of a plurality of light-emitting areas.

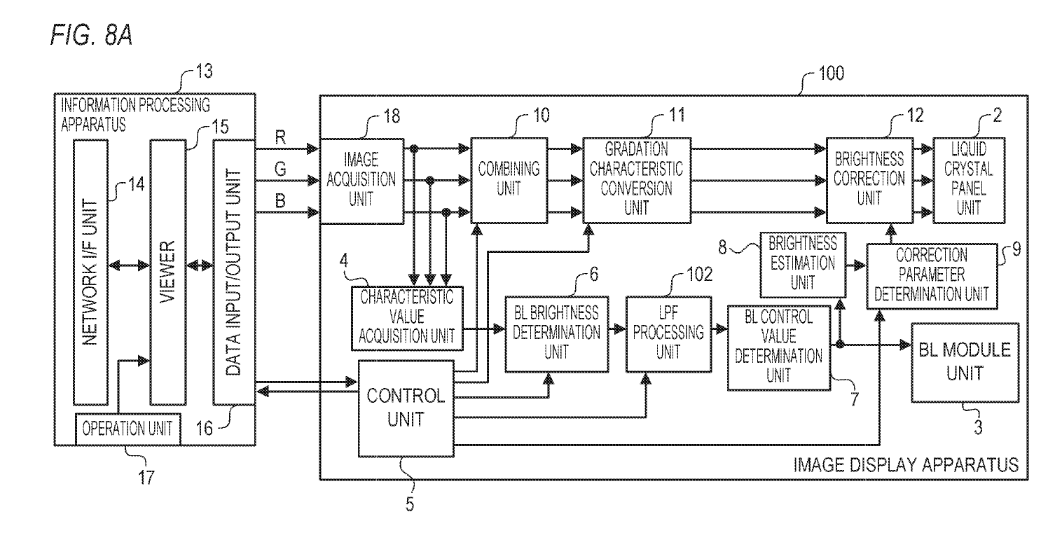

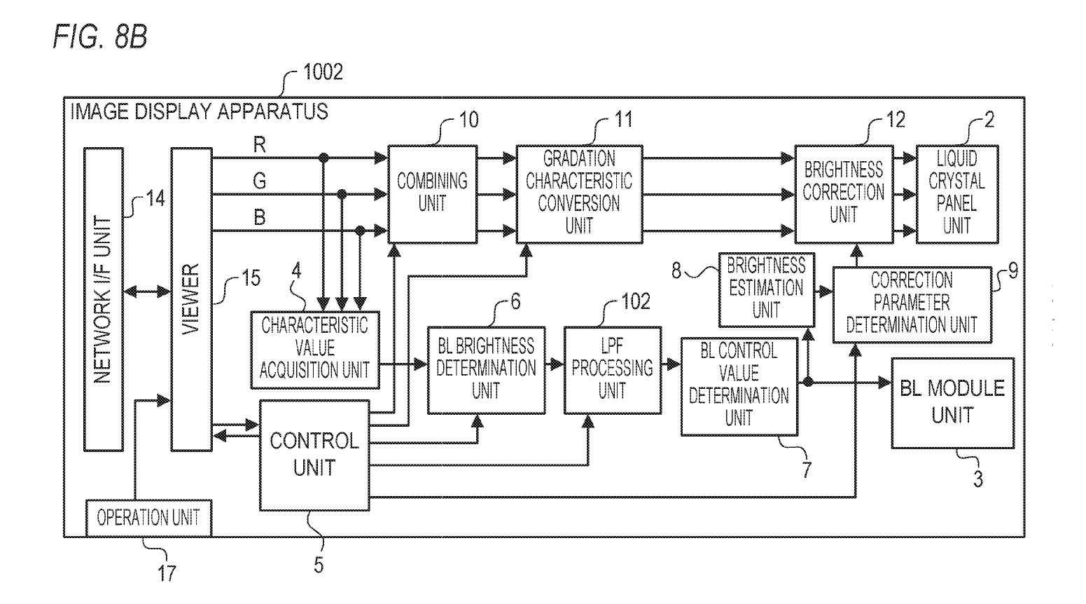

FIGS. 8A and 8B are block diagrams depicting examples of the functional configuration of the image display apparatus according to this example. In FIG. 8A, an image display apparatus 100 according to this example is used for an image display system which includes the information processing apparatus 13. In FIG. 8B, an image display apparatus 1002 according to this example further includes the functions of the information processing apparatus 13 in FIG. 8A.

The image display system in FIG. 8A will now be described in detail. The processing performed by the image display apparatus 1002 in FIG. 8B is the same as the processing performed by the image display system in FIG. 8A, hence detailed description on the image display apparatus 1002 in FIG. 8B will be omitted. As shown in FIG. 8A, the image display apparatus 100 includes the plurality of functional units of the image display apparatus 1 of Example 1, and an LPF processing unit 102.

The control unit 5 performs the range information acquisition, the area information acquisition and the HDR divided area detection, just like Example 1. Then just like Example 1, the control unit 5 outputs the range information to the BL brightness determination unit 6, the correction parameter determination unit 9, and the gradation characteristic conversion unit 11. In this example however, the control unit 5 outputs the HDR divided area detection result to at least the BL brightness determination unit 6. In this example, the emission brightness of each light-emitting area determined by the BL brightness determination unit 6 is corrected by the LPF processing unit 102, as described later in detail. The control unit 5 acquires the corrected brightness (emission brightness after correction) of each light-emitting area from the LPF processing unit 102, and corrects the HDR divided area detection result based on the corrected brightness of each light-emitting area. Then the control unit 5 outputs the correction result of the HDR divided area (detection result after correction) to the correction parameter determination unit 9, the combining unit 10 and the gradation characteristic conversion unit 11. As a result, the correction parameter determination unit 9, the combining unit 10 and the gradation characteristic conversion unit 11 performs the same processing as Example 1 using the corrected detection result as the HDR divided area detection result.

In this example, the HDR divided area detection result is corrected so that the target image data is corrected using each divided area corresponding to each light-emitting area, of which corrected brightness is outside the first brightness range, as the HDR divided area. In other words, the HDR divided area detection result is corrected so that each divided area corresponding to the light-emitting area, of which brightness is outside the first brightness range, is set as the HDR divided area, and the rest of the divided areas are set as the non-HDR divided areas.

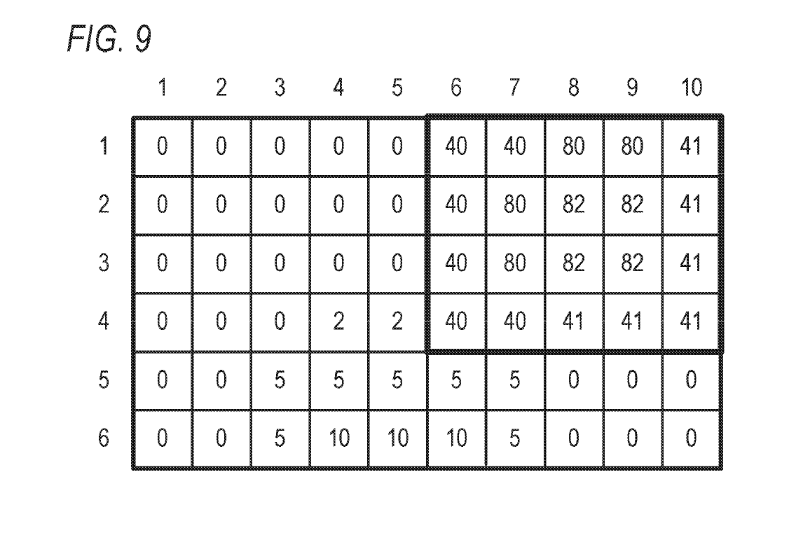

A case where the uncorrected HDR divided area detection result (detection result before correction) is the result shown in FIG. 3C and the corrected brightness is the emission brightness shown in FIG. 9 will be described. Just like Example 1, the maximum brightness in the first brightness range is 20%. In FIG. 9, the emission brightness exceeds 20% in 20 light-emitting areas of (6, 1) to (6, 4), (7, 1) to (7, 4), (8, 1) to (8, 4), (9, 1) to (9, 4) and (10, 1) to (10, 4). Therefore the HDR divided area detection result is corrected so that the divided areas corresponding to these 20 light-emitting areas are set as the HDR divided areas, and the rest of the divided areas are set as the non-HDR divided areas. The divided areas corresponding to the above mentioned 20 light-emitting areas are the 20 divided areas of (6, 1) to (6, 4), (7, 1) to (7, 4), (8, 1) to (8, 4), (9, 1) to (9, 4) and (10, 1) to (10, 4). In FIG. 3C, the 9 divided areas of (7, 1) to (7, 3), (8, 1) to (8, 3), (9, 1) to (9, 3) are set as the HDR divided area, and the rest of the divided areas are set as the non-HDR divided areas. Therefore the 11 divided areas of (6, 1) to (6, 4), (7, 4), (8, 4), (9, 4) and (10, 1) to (10, 4) are changed from the non-HDR divided area to the HDR divided area by the correction of the detection result.

The correction of the HDR divided area detection result may be omitted. However, if the HDR divided areas are corrected using the above method, the area where the HDR display is performed can be expanded by effectively utilizing the light from the BL module unit 3. As a result, an image having higher image quality can be provided to the user. The threshold to determine whether each divided area is set or not set as the HDR divided area is not limited to the maximum brightness or the minimum brightness in the first brightness range.

The BL brightness determination unit 6 determines the emission brightness of each light-emitting area by the same method as Example 1. In this example, however, the BL brightness determination unit 6 outputs the information indicating the emission brightness of each light-emitting area to the LPF processing unit 102, instead of the BL control value determination unit 7.

The LPF processing unit 102 performs the spatial LPF processing on the emission brightness of each light-emitting area determined by the BL brightness determination unit 6. Thereby the emission brightness of each light-emitting area is corrected. The LPF processing unit 102 outputs the information indicating the corrected brightness (emission brightness after correction) of each light-emitting area to the control unit 5 and the BL control value determination unit 7.

An example of the spatial LPF processing will be described. First the LPF processing unit 102 detects a light-emitting area Max (N) of which emission brightness is highest, from a plurality of light-emitting areas that exist around the target light-emitting area N. For example, the light-emitting areas that exist around the target light-emitting area N are light-emitting areas of which distances from the target light-emitting area N are a threshold or less. In this example, the light-emitting area Max (N) is detected from a plurality of light-emitting areas adjacent to the target light-emitting area N. For the threshold, a value corresponding to two or more light-emitting areas may be used. In other words, the light-emitting areas outside the light-emitting areas adjacent to the target light-emitting area N may also be used as the light-emitting areas that exist around the target light-emitting area N.

Then the LPF processing unit 102 compares the emission brightness L (N) of the target light-emitting area N with a value of the emission brightness L (Max (N)) of the light-emitting area Max (N) multiplied by a coefficient α. If α×L (Max (N)) is greater than L (N), the LPF processing unit 102 replaces the emission brightness L (N) of the target light-emitting area N with α×L (Max (N))). If α×L (Max (N))) is L (N) or less, the LPF processing unit 102 does not replace the emission brightness of the target light-emitting area N.

The LPF processing unit 102 selects each of the plurality of light-emitting areas as the target light-emitting area N, and performs the above mentioned processing. If α=0.5, the distribution shown in FIG. 5C is corrected to the distribution shown in FIG. 9.

The coefficient α may be greater or less than 0.5. The coefficient α may be determined or changed based on the degree of the diffusion of light from the light-emitting area, the change amount of the emission brightness of the light-emitting area or the like. The spatial LPF processing is not limited to the above processing. Various prior arts to smooth the distribution of values can be used for the spatial LPF processing.

As described above, in this example as well, the areas where the HDR display is performed are limited to the HDR divided areas. Therefore, the power consumption of the image display apparatus during the HDR display can be reduced, and the eye fatigue of the user in a case of viewing the HDR display can be eased. Information on the areas on the screen where the HDR display is performed are notified to the user. Thereby the user can easily recognize: the areas where the HDR display is performed; and the other areas. Further, according to this example, the distribution of the emission brightness in the plurality of light-emitting areas can be smoothed. Therefore deterioration of the image quality of the display image (e.g. generation of halo, generation of flicker in a case where moving image is displayed) can be suppressed.

### Example 3

An image display apparatus according to Example 3 of the present invention will now be described. In the following, the configuration and processing that are different from Example 1 will be described in detail, and description on the configuration and processing that are the same as Example 1 will be omitted. An example in a case where a characteristic configuration of this example is applied to the configuration of Example 1 will be described below, but the characteristic configuration of this example is applicable to the configuration of Example 2 as well.

In Examples 1 and 2, information on the areas on the screen, where the HDR display is performed, are notified to the user. However, the light from each light-emitting area diffuses around the area. Therefore in a peripheral area around the area where the HDR display is performed, the irradiation brightness may be controlled to the brightness far higher than the irradiation brightness in the case of not performing the HDR display. As a result, in a peripheral area around the area where the HDR display is performed, display at an accurate brightness (desired brightness) becomes impossible in some cases. It becomes particularly difficult to display low gradation values at an accurate brightness. Therefore in this example, information on an area where display at an accurate brightness becomes difficult (affected area) is notified to the user. Thereby the user can easily recognize the affected area, and non-recognition by the user, that the brightness of the affected area may not be an accurate brightness, is prevented.

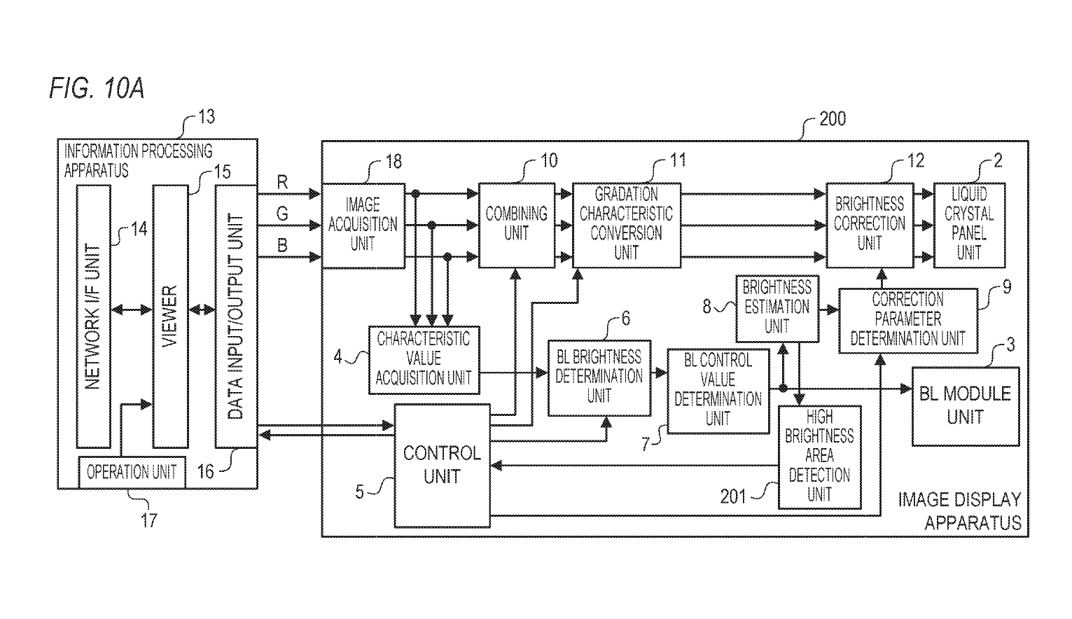

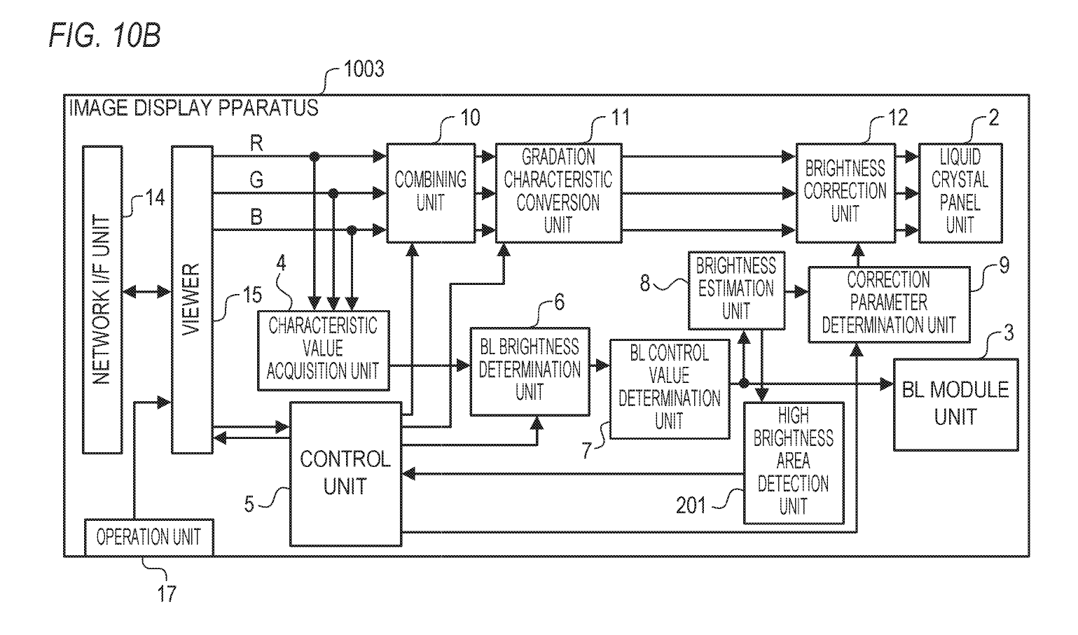

FIGS. 10A and 10B are block diagrams depicting examples of the functional configuration of the image display apparatus according to this example. In FIG. 10A, an image display apparatus 200 according to this example is used for an image display system which includes the information processing apparatus 13. In FIG. 10B, an image display apparatus 1003 according to this example further includes the functions of the information processing apparatus 13 in FIG. 10A.

The image display system in FIG. 10A will be described in detail. The processing performed in the image display apparatus 1003 in FIG. 10B is the same as the processing performed by the image display system in FIG. 10A, hence detailed description on the image display apparatus 1003 in FIG. 10B will be omitted. As shown in FIG. 10A, the image display apparatus 200 includes the plurality of functional units of the image display apparatus 1 of Example 1, and a high brightness area detection unit 201.

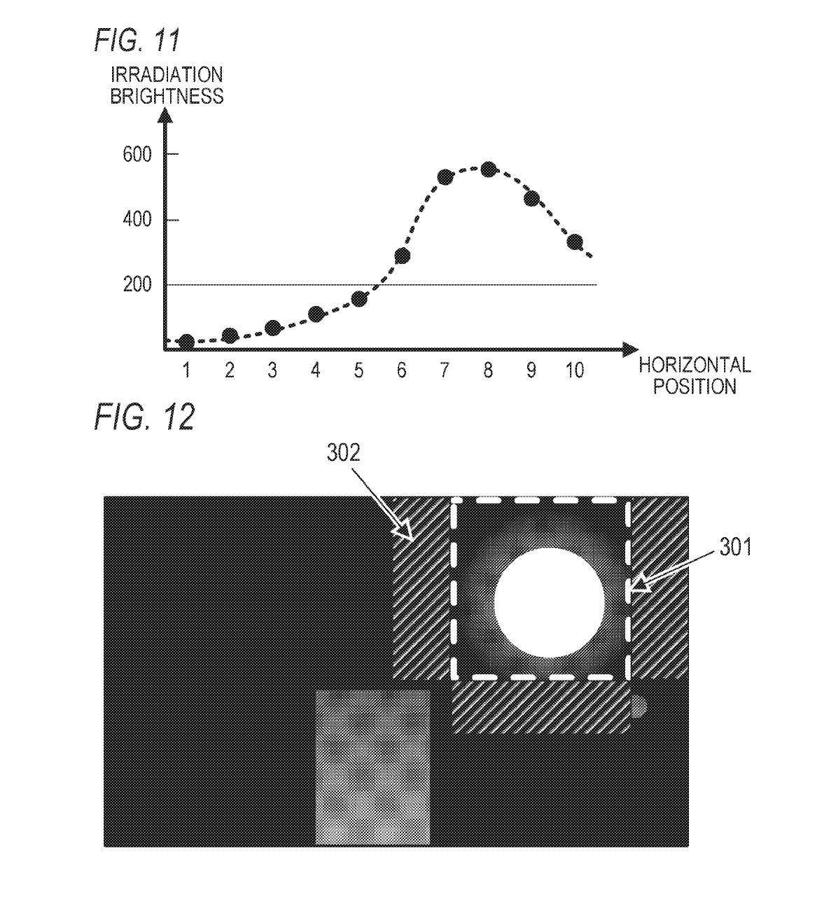

The high brightness area detection unit 201 acquires an irradiation brightness estimation result from the brightness estimation unit 8, and detects an area on the screen where the irradiation brightness is a threshold or more as a high brightness area. The high brightness area detection unit 201 outputs the high brightness area detection result to the control unit 5. FIG. 11 shows an example of the estimated irradiation brightness distribution. The abscissa in FIG. 11 indicates a horizontal position, and the ordinate in FIG. 11 indicates an irradiation brightness. A black dot in FIG. 11 indicates the irradiation brightness at each estimation position, and the broken line in FIG. 11 indicates the result of interpolating the irradiation brightness at each estimation position. To simplify description, the high brightness area detection method will be described using an irradiation brightness distribution in the horizontal direction. If the threshold is 200, 5 divided areas, of which horizontal positions are 6 to 10, are detected as high brightness areas.

The threshold used to compare each irradiation brightness may be a fixed value determined in advance by the manufacturer, or may be a value that the user can change. The threshold may be automatically determined according to the type of target image data, the working environment (e.g. ambient brightness) of the image display apparatus and the like. If individual control (local dimming processing) is not performed for each light-emitting area, the emission brightness of all the light-emitting areas is controlled to a standard brightness. As the threshold used to compare with the irradiation brightness, an irradiation brightness, in a case where the emission brightness of all the light-emitting areas is controlled to the standard brightness, may be used. As the threshold used to compare with the irradiation brightness, the maximum brightness of the first brightness range may be used. Further, as the threshold used to compare with the irradiation brightness, the allowable maximum value of the irradiation brightness, in a case where the local dimming processing is performed to enable display in the SDR, may be used.

The control unit 5 performs the same processing as Example 1. Furthermore, the control unit 5 acquires the high brightness area detection result from the high brightness area detection unit 201. Then the control unit 5 detects the high brightness areas, excluding the correspondence divided areas, as the affected areas, and outputs the affected area detection result to the combining unit 10. For example, a case where the 5 divided areas of which horizontal positions are 6 to 10 are the high brightness areas, and the 3 divided areas of which horizontal positions are 7 to 9 are the HDR divided areas, is considered with reference to FIG. 11. In this case, the control unit 5 outputs information indicating 3 divided areas of which horizontal positions are 7 to 9, as the HDR divided area detection result, and outputs the information indicating the 2 divided areas of which horizontal positions are 6 and 10, as the affected area detection result.

The combining unit 10 performs first combining processing and second combining processing. In the first combining processing, first graphic image data representing a first graphic image is combined based on the HDR divided area detection result, so that the first graphic image is displayed in addition to the image based on the corrected target image data. In the second combining processing, second graphic image data representing a second graphic image is combined based on the affected area detection result, so that the second graphic image is displayed in addition to the image based on the corrected target image data. Thereby a combined image data combining the first graphic image data and the second graphic image data with the target image data is generated. The combining unit 10 outputs the combined image data to the gradation characteristic conversion unit 11. The first combining processing may be omitted.

The first graphic image is a graphic image showing the HDR display area, and the second graphic image is an image showing the affected area. FIG. 12 shows an example of an image based on the combined image data (combined image). In FIG. 12, the broken line 301 indicates the first graphic image, and the hatched image 302 indicates the second graphic image. By the display of the first graphic image, information on the HDR display area is notified to the user, and by the display of the second graphic image, information on the affected area is notified to the user. In other words, the user can recognize the HDR display area by viewing the first graphic image displayed on the screen, and can recognize the affected area by viewing the second graphic image displayed on the screen.

The irradiation brightness is estimated based on the emission brightness (BL control value) of each light-emitting area, and the affected area is detected based on the HDR divided area detection result and the estimated distribution of the irradiation brightness. Therefore the second combining processing can also be processing of combining the second graphic image data based on the HDR divided area detection result and the emission brightness of each light-emitting area.

The first graphic image and the second graphic image are not limited to the images shown in FIG. 12. Any image may be used as the first graphic image as long as the information on the HDR display area information can be notified to the user. Further, any image may be used as the second graphic image as long as information on the affected area can be notified to the user. For example, a message image indicating the HDR display area may be used as the first graphic image. In concrete terms, such a message image as “HDR display is performed on right half surface” or “start coordinate is A and end coordinate is B in HDR display area” may be used as the first graphic image. A graphic image, which indicates the screen and in which an area corresponding to the HDR display area is differentiated from other areas, may be used as the first graphic image. A message image to indicate the affected area may be used as the second graphic image. A graphic image which indicates the screen and in which an area corresponding to the affected area is differentiated from other areas, may be used as the second graphic image. An image having a predetermined transparency and predetermined colors may be used as a second graphic image that is superimposed on the affected area.

As described above, according to this example, information on the affected area is notified to the user. Thereby the user can easily recognize the affected area, and non-recognition by the user, that the brightness of the affected area may not be an accurate brightness, can be prevented.

### Example 4

An image display apparatus according to Example 4 of the present invention will now be described. In the following, the configuration and processing that are different from Examples 1 to 3 will be described in detail, and description on the configuration and processing that are the same as Examples 1 to 3 will be omitted.

In Examples 1 to 3, the user specifies an area in which the HDR display is desired, and the emission brightness of each light-emitting area corresponding to the specified area is controlled to be the brightness higher than the other light-emitting areas, and the information on the area where the HDR display is performed is notified to the user. Here “other light-emitting areas” refers to areas corresponding to the SDR display areas (areas other than the specified area: areas where the SDR display is performed).

In this example, an area where the HDR display should be performed (called “HDR-recommended area”) is detected based on the characteristic value of the input image data, and information on the HDR-recommended area is notified to the user. If the user instructs to execute the HDR display in the HDR-recommended area after information on the HDR-recommended area is notified, the HDR display is performed in the HDR-recommended area. The instruction to execute the HDR display in the HDR-recommended area is received via a user I/F unit (user interface unit). Thereby such a state as the user not recognizing the HDR display image (display image in the area where the HDR display is performed) can be prevented, and convenience of viewing the image quality of the display image, in a case where both the HDR display and the SDR display are performed on the same screen, can be improved.

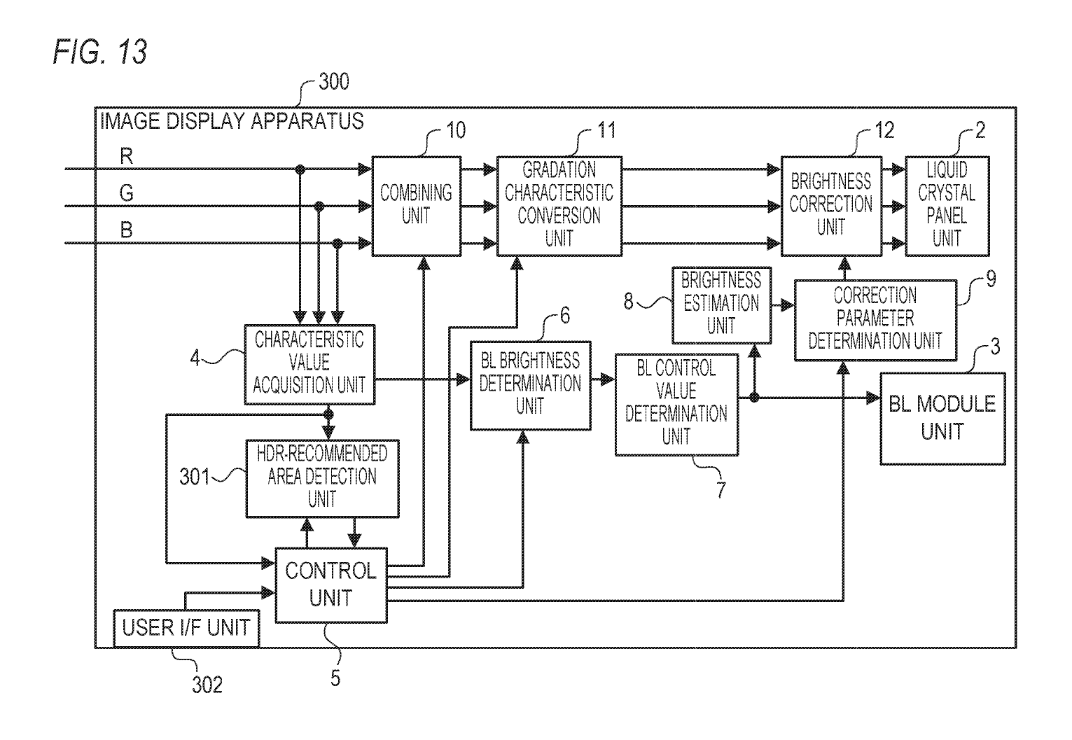

FIG. 13 is a block diagram depicting an example of the functional configuration of the image display apparatus 300 according to this example. As shown in FIG. 13, the image display apparatus 300 includes a plurality of functional units of the image display apparatus 1 of Example 1, an HDR-recommended area detection unit 301 and a user I/F unit 302.

The HDR-recommended area detection unit 301 detects each divided area which includes an HDR pixel from a plurality of divided areas as an HDR-recommended area (specific area) based on the brightness characteristic value of each divided area. Then the HDR-recommended area detection unit 301 outputs the HDR-recommended area detection result to the control unit 5. “HDR pixel” is a pixel having the HDR (in the second dynamic range). “Divided area which includes an HDR pixel” is a divided area corresponding to the image data that includes an HDR pixel. “Divided area which includes an HDR pixel” can also be defined as a divided area where an HDR pixel exists.

In this example, the maximum gradation value is used as the brightness characteristic value. The HDR-recommended area detection unit 301 receives information on the SDR and the gradation values (boundary gradation values), corresponding to the boundary with the range of the gradation values which belong not to the SDR but to the HDR, from the control unit 5. The HDR, the boundary gradation values and the like are specified according to the format of the input image data, for example. The HDR-recommended area detection unit 301 compares the brightness characteristic value (maximum gradation value) of each divided area with the acquired boundary gradation value. Then the HDR-recommended area detection unit 301 determines a divided area of which brightness characteristic value (maximum gradation value) is greater than the boundary gradation value, as the HDR-recommended area.

The brightness characteristic value is not limited to the maximum gradation value. For example, a histogram of the gradation value may be used for the brightness characteristic value. If a histogram is used, a divided area, in which the highest number of the HDR pixels are included among the plurality of divided area, may be detected as an HDR-recommended area. All the divided areas in which at least a predetermined number of the HDR pixels are included may be detected as the HDR-recommended area. Each divided area, of which distance from the HDR-recommended area is a threshold or less and which includes an HDR pixel, may be additionally detected as an HDR-recommended area. For example, each divided area, which adjoins the HDR-recommended area and which includes an HDR pixel, may be additionally detected as an HDR-recommended area.

The user I/F unit 302 receives the user operation (instruction from user). Then the user I/F unit 302 outputs information corresponding to the instruction from the user to the control unit 5. For example, the user I/F unit 302 receives an instruction on the range information from the user, and outputs the range information to the control unit 5. The “instruction on range information” is a specification of the HDR, for example.

The control unit 5 of this example acquires the range information from the user I/F unit 302, acquires the brightness characteristic value of each divided area from the characteristic value acquisition unit 4, and acquires the HDR-recommended area detection result from the HDR-recommended area detection unit 301. Then the control unit 5 notifies information on the HDR-recommended area detection result (e.g. coordinates of the HDR-recommended area) to the combining unit 10, in order to notify information on the HDR-recommended area to the user. In order to display the HDR-recommended area detection result as a graphic image, the combining unit 10 combines a graphic image data representing the graphic image. For example, the graphic image data is combined with the target image data (input image data) before correction. Thereby a combined image data, in which the graphic image data is combined with the target image data before correction, is generated. Then the combining unit 10 outputs the combined image data to the gradation characteristic conversion unit 11.

The image data with which the graphic image data is combined is not especially limited. The graphic image data may be combined with the target image data which was corrected such that the SDR display is performed on the entire screen.

The graphic image is, for example, an image indicated by the broken line 131 in FIG. 3B (rectangular frame image). By the display of the graphic image, the information on the HDR-recommended area is notified to the user. In other words, the user can recognize the location of an HDR-recommended area, the presence/absence of an HDR-recommended area and the like by viewing the displayed graphic image.

After the graphic image is displayed, the user can instruct the image display apparatus 300 (user I/F unit 302) whether to perform the HDR display in the HDR-recommended area. The instruction whether to perform the HDR display in the HDR-recommended area is, for example, an instruction to perform the HDR display in the HDR-recommended area and an instruction to not perform HDR display in the HDR-recommended area. One of these instructions, to perform the HDR display in the HDR-recommended area and not to perform the HDR display in the HDR-recommended area, may be omitted. In other words, if the instruction to perform the HDR display in the HDR-recommended area is not received, it may be regarded that the instruction to not perform the HDR display in the HDR-recommended area is received. When the instruction to not perform the HDR display in the HDR-recommended area is not received, it may be regarded that the instruction to perform HDR display in the HDR-recommended area is received.

When the user instructs whether to perform the HDR display in the HDR-recommended area, the information corresponding to this instruction is output from the user I/F unit 302 to the control unit 5. The control unit 5 determines whether an instruction was received to perform the HDR display in the HDR-recommended area according to the information received from the user I/F unit 302. If it is instructed to perform the HDR display in the HDR-recommended area, the control unit 5 outputs the HDR-recommended area detection result and the range information to the BL brightness determination unit 6, the correction parameter determination unit 9, and the gradation characteristic conversion unit 11, just like Example 1. In the BL brightness determination unit 6, the correction parameter determination unit 9 and the gradation characteristic conversion unit 11, the same processing as Example 1 is performed. As a consequence, the HDR display is performed in the HDR-recommended area if it is instructed to perform the HDR display in the HDR-recommended area, and the SDR display is performed in the HDR-recommended area if not instructed to perform HDR display in the HDR-recommended area. In areas other than the HDR-recommended area, the SDR display is performed.

The control unit 5 may generate the range information from the brightness characteristic value of each divided area. For example, the range information may be generated so that the maximum value of the brightness characteristic value (maximum gradation value) in the HDR-recommended area is set as the maximum value of the gradation value belonging to the HDR.

As described above, according to this example, the HDR-recommended area (area where the HDR display should be performed) is automatically detected, the information is notified to the user, and the HDR display or the SDR display is selected for the display in the HDR-recommended area according to the instruction received from the user thereafter. As a result, the effect of Example 1 is acquired, and such a situation as the user not recognizing the image quality of the HDR display image can be prevented.

In this example, the information on the HDR-recommended area is notified to the user by displaying the graphic image on the screen of the image display apparatus 300, but the way of notifying the information on the HDR-recommended area to the user is not limited to this. For example, the image display apparatus 300 may be linked with an external apparatus (an application of the external apparatus) so that the information on the HDR-recommended area is notified to the user by displaying the graphic image on the screen of the external apparatus. The external apparatus is, for example, a tablet PC, a workstation or the like.

### Example 5

An image display apparatus according to Example 5 of the present invention will now be described. In the following, the configuration and processing that are different from Examples 1 to 4 will be described in detail, and description on configuration and processing that are the same as Examples 1 to 4 will be omitted.

In Example 4, the information on the automatically detected HDR-recommended area is notified to the user. However, in the image display apparatus, if a plurality of the HDR-recommended areas are detected, the processing to “perform the HDR display for all the HDR-recommended areas” (ideal processing) may become impossible to execute. For example, in a case where the image display apparatus is powered by battery, the ideal processing may become impossible to execute because of the limit of the power supply capacity. Therefore in this example, in a case where ideal processing should not be executed, and in a case where there are a plurality of combined-recommended areas (collecting specific areas) each of which is an area constituted by at least one HDR-recommended area, a priority (a precedent) is assigned to each of the plurality of combined-recommended areas respectively. Then information on the priority of each combined-recommended area is notified to the user. Thereby the user can recognize the state that ideal processing cannot be executed (should not be executed), and can receive such information as a combined-recommended area having high priority to perform the HDR display. As a result, even if the ideal processing cannot be executed, such a situation as the user not recognizing the image quality of the HDR display image can be prevented.

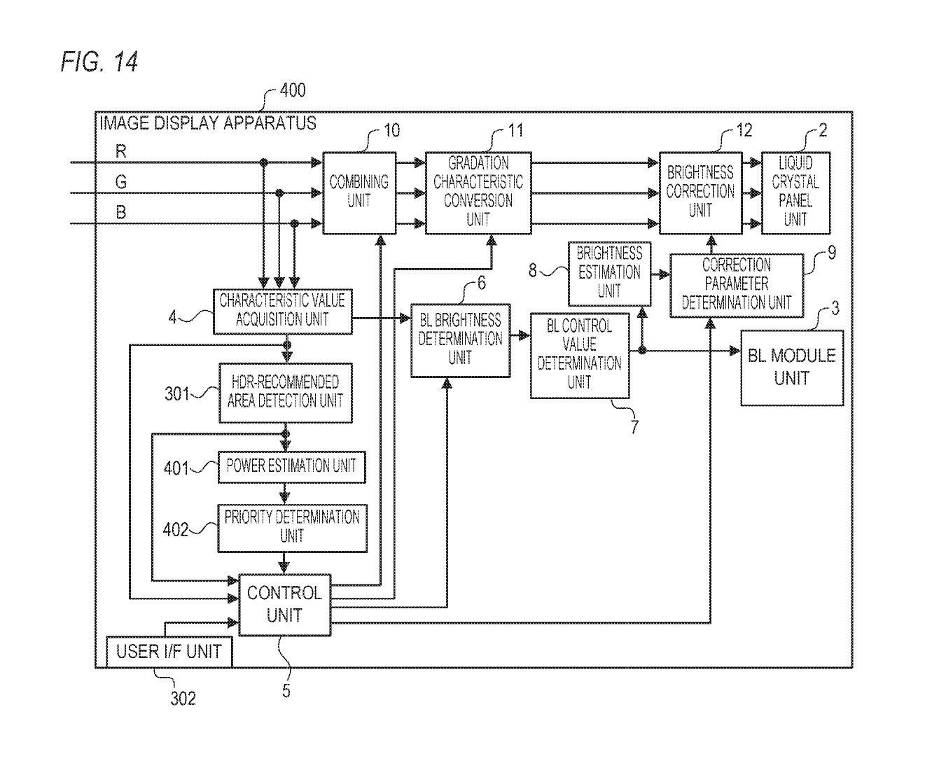

FIG. 14 is a block diagram depicting an example of the functional configuration of the image display apparatus 400 according to this example. As shown in FIG. 14, the image display apparatus 400 includes a plurality of functional units of the image display apparatus 300 of Example 4, a power estimation unit 401 and a priority determination unit 402.

The power estimation unit 401 estimates the power that is used in the image display apparatus 400 (BL module unit 3). For example, the power estimation unit 401 estimates power in the case where the HDR display is performed in all the HDR-recommended areas. Then the power estimation unit 401 outputs the power estimation result to the priority determination unit 402. The power estimation method is not especially limited. If the BL control value determined by the BL control value determination unit 7 is used, power can be estimated at high accuracy. In this example, the power estimation unit 401 roughly estimates power from the HDR-recommended area detection result, the range information and the brightness characteristic value of each divided area. In concrete terms, the target brightness determined by the BL brightness determination unit 6 is estimated, and power is estimated from the estimated target brightness.

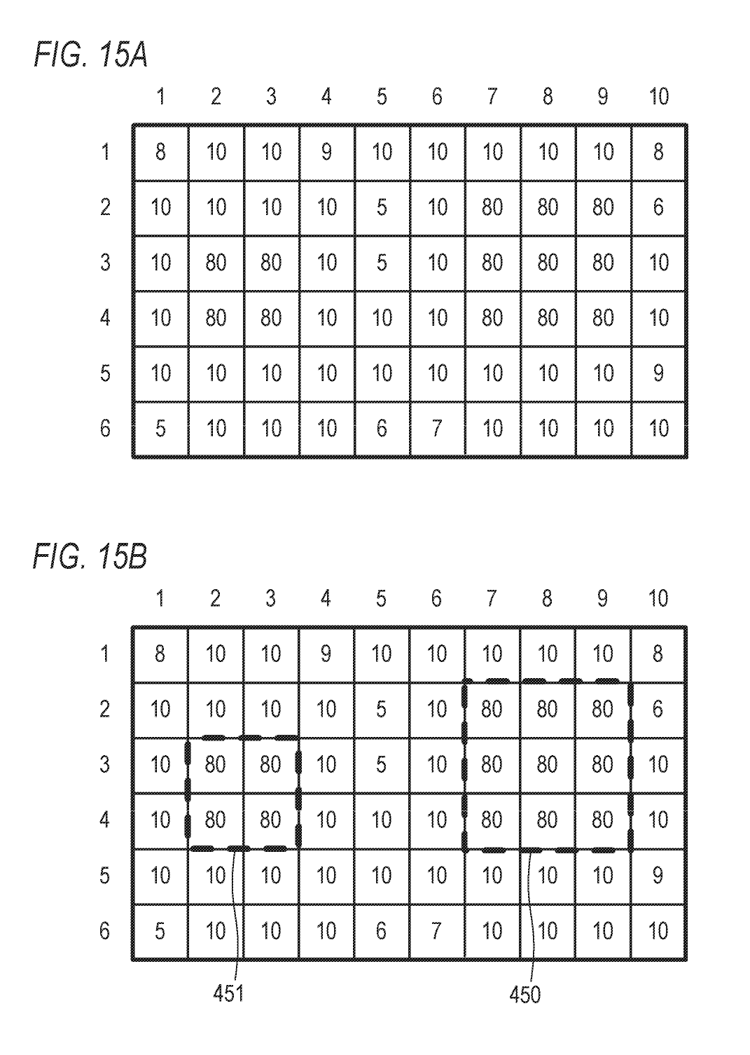

A case where the target brightness of each light-emitting area is the value shown in FIG. 15A is considered. Here it is assumed that the maximum value of the target brightness in the case where the HDR display is not performed, that is, the target brightness in the case where local dimming processing is not performed, is 10. The total target brightness values shown in FIG. 15A is 1493. On the other hand, the total target brightness values in the case where local dimming processing is not performed is 10×60 (number of light-emitting areas)=600. Therefore in FIG. 15A, the BL module unit 3 turns ON at brightness 1493/600≅2.48 times the brightness in the case where local dimming processing is not performed. If it is assumed that the power of the BL module unit 3, in the case where local dimming processing is not performed, is A, then the power in the case of FIG. 15A is estimated as 2.48×A.

The priority determination unit 402 determines a combined-recommended area based on the HDR-recommended area detection result. If there are a plurality of combined-recommended area, the priority determination unit 402 determines whether ideal processing of “performing the HDR display in all the HDR-recommended areas (all combined-recommended areas)” should be performed, based on the power estimated by the power estimation unit 401. Whether the ideal processing can be performed or not depends on the specification of the power supply of the image display apparatus 400. Therefore in this example, the priority determination unit 402 determines that the ideal processing can be performed if the power estimated by the power estimation unit 401 is a threshold or more. The threshold to be compared with the power may be a fixed value determined in advance by the manufacturer, or may be a value that can be changed depending on the state of the image display apparatus 400, an instruction from the user or the like.

If it is determined that the ideal processing should not be performed, the priority determination unit 402 determines the priority of each combined-recommended area, and outputs the priority of each combined-recommended area to the control unit 5. In this example, the priority is determined based on the size of each combined-recommended area. As the size of the combined-recommended area becomes smaller, the possibility that the HDR display can be performed in all the HDR-recommended areas including this combined-recommended area is higher. Therefore the priority determination unit 402 determines the higher priority for a combined-recommended area as the size of the combined-recommended area becomes smaller. If the target brightness of each light-emitting area (each divided area) is the value shown in FIG. 15A, then two combined-recommended areas 450 and 451 are determined, as shown in FIG. 15B. The combined-recommended area 450 includes 9 divided areas, and the combined-recommended area 451 includes 4 divided areas. Therefore higher priority is determined for the combined-recommended area 451 than for the combined-recommended area 450.

The control unit 5 of this example performs control similar to the control described in Examples 1 to 4. However if priority of each combined-recommended area is output from the priority determination unit 402, the control unit 5 of this example notifies the information on the priority of the HDR-recommended area detection result and of each combined-recommended area to the combining unit 10, in order to notify the priority in addition to the information on the HDR-recommended area to the user. To display the HDR-recommended area detection result and the priority of each combined-recommended area as a graphic image, the combining unit 10 combines the graphic image data representing this graphic image. For example, the graphic image data is combined with the target image data before correction. Thereby the combined image data, in which graphic image data is combined with the target image data before correction, is generated. Then the combining unit 10 outputs the combined image data to the gradation characteristic conversion unit 11.

The image data with which the graphic image data is combined is not especially limited. The graphic image data may be combined with the target image data which was corrected so that the SDR display is performed on the entire screen.

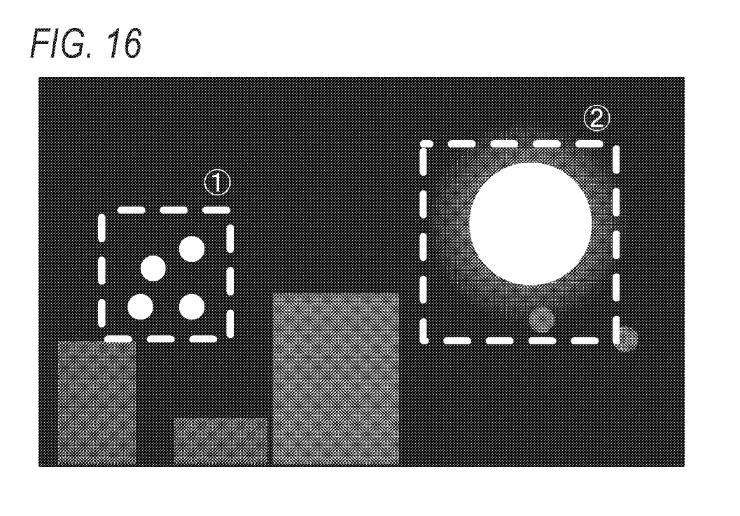

The graphic image is, for example, an image that includes an image indicated by the broken line in FIG. 16 (a rectangular frame image) and numbers. Numbers 1 and 2 in FIG. 16 indicate precedence based on the assigned priority. The broken line corresponding to precedence 1 indicates the combined-recommended area 450 in FIG. 15B, and the broken line corresponding to precedence 2 indicates the combined-recommended area 451. By the display of the graphic image, the information on the HDR-recommended area (combined-recommended area) is notified to the user. In other words, the user can recognize the location of an HDR-recommended area, the presence/absence of an HDR-recommended area and the like by viewing the displayed graphic image. Further, by the display of the graphic image, the priority of each combined-recommended area is notified to the user. In other words, the user can recognize the priority of each combined-recommended area and the like by viewing the displayed graphic image. Furthermore the priority is also notified in a case where it is determined that the ideal processing should not be executed, therefore the user can recognize that the ideal processing should not be executed by viewing the displayed graphic image.

Processing after display of the graphic image, which indicates the HDR-recommended area detection result and the priority of each combined-recommended area, is not especially limited. For example, the ideal processing may be executed according to an instruction to perform the HDR display in the HDR-recommended area, or the HDR display may be performed only for the combined-recommended area having the highest priority. The number of combined-recommended areas, where the HDR display can be performed may be selected sequentially from the highest priority, and the HDR display may be performed only in the selected combined-recommended area. Further, the user I/F unit 302 may receive an instruction on a combined-recommended area where the HDR display is performed and a combined-recommended area where the HDR display is not performed, from the user, and the processing according to this instruction may be performed. In concrete terms, the HDR display may be performed only in the combined-recommended area, which was specified by the user as a combined-recommended area where the HDR display is performed.

As described above, according to this example, in the case where a plurality of combined-recommended areas exist and the ideal processing should not be executed, not only the HDR-recommended area detection result but also the priority of each combined-recommended area are notified to the user. Thereby a convenience of recognizing the image quality for the display image can be further improved. In concrete terms, the user can recognize a situation where the ideal processing cannot be executed (should not be executed), a combined-recommended area where the HDR display should be performed with priority and the like. As a result, such a situation as the user not recognizing the image quality of the HDR display image can be prevented, even if the ideal processing cannot be executed.

In the description of this example, a higher priority is determined as the size of the combined-recommended area becomes smaller, but the present invention is not limited to this. For example, higher priority may be determined as the size of the combined-recommended area becomes larger, or higher priority may be determined as the size of the combined-recommended area is closer to a predetermined size. Priority may be determined based on information other than the size of the combined-recommended area. For example, priority may be determined based on the concentration of frequencies of a gradation value in a histogram. In concrete terms, higher priority is determined as the concentration of frequencies is higher, or higher priority is determined as the gradation value, of which frequencies concentrate, is closer to a predetermined gradation value. The predetermined gradation value is, for example, a value which does not belong to the SDR but to the HDR. Further, the information that ideal processing should not be executed may be notified via a graphic image in the case where the number of combined-recommended areas is 1, and the ideal processing should not be executed.

### Other Embodiments

Embodiment(s) of the present invention can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment (s) and/or controlling the one or more circuits to perform the functions of one or more of the above-described embodiment (s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present invention has been described with reference to exemplary embodiments, it is to be understood that the invention is not limited to the disclosed exemplary embodiments. The scope of the following claims is to be accorded the broadest interpretation so as to encompass all such modifications and equivalent structures and functions.

This application claims the benefit of Japanese Patent Application No. 2015-166745, filed on Aug. 26, 2015, and Japanese Patent Application No. 2016-062144, filed on Mar. 25, 2016, which are hereby incorporated by reference herein in their entirety.

What is claimed is:

1. An image display apparatus comprising:
a light-emitting unit which has a plurality of light-emitting areas respectively corresponding to a plurality of divided areas constituting an area on a screen;
a display unit configured to display an image on the screen by modulating light from the light-emitting unit based on image data;
a characteristic value acquisition unit configured to acquire, for each of the plurality of divided areas, a brightness characteristic value of image data corresponding to the divided area, from input image data;
a first information acquisition unit configured to acquire range information indicating a second dynamic range, which is wider than a first dynamic range determined in advance;
a second information acquisition unit configured to acquire area information indicating a specific area, which is an image area where display is performed in the second dynamic range;
a detection unit configured to detect a correspondence divided area, which is a divided area corresponding to the specific area, from the plurality of divided areas based on the area information; and
a control unit configured to perform individual control of emission brightness of each light-emitting area and correction of the input image data, based on the brightness characteristic value of each divided area, the range information and the detection result of the correspondence divided area, so that display in the first dynamic range is performed in a non-correspondence divided area, which is a divided area other than the correspondence divided area, and display in the second dynamic range is performed in the correspondence divided area.

2. The image display apparatus according to claim 1, wherein
the control unit includes a first combining unit configured to, so that a first graphic image indicating the area on the screen where display is performed in the second dynamic range is displayed in addition to an image based on the corrected image data, combine first graphic image data representing the first graphic image based on the detection result of the correspondence divided area.

3. The image display apparatus according to claim 1, wherein
the control unit includes:
a determination unit configured to determine the emission brightness of each light-emitting area based on the brightness characteristic value of each divided area, the range information and the detection result of the correspondence divided area; and
a correction unit configured to correct the input image data based on the range information, the detection result of the correspondence divided area and the emission brightness of each light-emitting area, and
the determination unit determines, for each of the plurality of light-emitting areas, the emission brightness of the light-emitting area based on the brightness characteristic value of a divided area corresponding to the light-emitting area, by using a first brightness range corresponding to the first dynamic range as a range of the emission brightness of a light-emitting area corresponding to the non-correspondence divided area, and by using a second brightness range corresponding to the second dynamic range as a range of the emission brightness of a light-emitting area corresponding to the correspondence divided area.

4. The image display apparatus according to claim 3, wherein
a ratio of the first brightness range and the second brightness range matches a ratio of the first dynamic range and the second dynamic range.

5. The image display apparatus according to claim 3, wherein
minimum brightness of the first brightness range matches minimum brightness of the second brightness range,
the brightness characteristic value of the divided area is a maximum gradation value of image data corresponding to the divided area,
for a light-emitting area corresponding to a divided area in which an acquired maximum gradation value is not more than a gradation value corresponding to maximum brightness of the first dynamic range, the determination unit determines emission brightness that increases from the minimum brightness of the first brightness range to maximum brightness of the first brightness range as the maximum gradation value increases,
for a light-emitting area corresponding to a non-correspondence divided area in which an acquired maximum gradation value is greater than the gradation value corresponding to the maximum brightness of the first dynamic range, the determination unit determines emission brightness that is identical to the maximum brightness of the first brightness range,
for a light-emitting area corresponding to a correspondence divided area in which an acquired maximum gradation value is not less than the gradation value corresponding to the maximum brightness of the first dynamic range and not more than a gradation value corresponding to maximum brightness of the second dynamic range, the determination unit determines emission brightness that increases from the maximum brightness of the first brightness range to maximum brightness of the second brightness range as the maximum gradation value increases, and
for a light-emitting area corresponding to a correspondence divided area in which an acquired maximum gradation value is greater than the gradation value corresponding to the maximum brightness of the second dynamic range, the determination unit determines emission brightness that is identical to the maximum brightness of the second brightness range.

6. The image display apparatus according to claim 3, wherein
the correction unit performs, on the input image data:
conversion processing for converting a gradation characteristic of image data based on the range information and the detection result of the correspondence divided area, so that a brightness range of the screen corresponding to a range of a gradation value of the image data matches the first dynamic range in the non-correspondence divided area, and the brightness range of the screen corresponding to the range of the gradation value of the image data matches the second dynamic range in the correspondence divided area; and
correction processing for correcting a gradation value of image data based on the range information, the detection result of the correspondence divided area and the emission brightness of each light-emitting area, so that display is performed in the non-correspondence divided area at brightness that is identical to brightness in a case where irradiation brightness, which is brightness of the light emitted from the light-emitting unit and irradiated to the display unit, matches maximum brightness of the first dynamic range, and display is performed in the correspondence divided area at brightness that is identical to brightness in a case where the irradiation brightness matches maximum brightness of the second dynamic range.

7. The image display apparatus according to claim 3, wherein
the control unit further includes a smoothing unit configured to correct emission brightness of each light-emitting area determined by the determination unit so that the distribution of the emission brightness of the plurality of light-emitting areas becomes smooth.

8. The image display apparatus according to claim 7, wherein
the detection unit corrects the detection result of the correspondence divided area, so that the input image data is corrected using, as the correspondence divided area, the divided area corresponding to the light-emitting area of which emission brightness after the correction by the smoothing unit is outside the first brightness range.

9. The image display apparatus according to claim 3, wherein
the correction unit estimates irradiation brightness, which is brightness of the light emitted from the light-emitting unit and irradiated to the display unit, based on the emission brightness of each light-emitting unit, and corrects the input image data based on the range information, the detection result of the correspondence divided area and the estimation result of the irradiation brightness.

10. The image display apparatus according to claim 1, wherein
the control unit includes a second combining unit configured to, so that a second graphic image indicating an area on the screen which is other than the correspondence divided area and in which brightness of the light emitted from the light-emitting unit and irradiated to the display unit is not less than a threshold is displayed in addition to an image based on the corrected image data, combine second graphic image data representing the second graphic image based on the detection result of the correspondence divided area and the emission brightness of each light-emitting area.

11. The image display apparatus according to claim 1, wherein
the detection unit detects a divided area, in which at least a part of the specific area is displayed, as the correspondence divided area.

12. The image display apparatus according to claim 1, wherein
the area information is acquired according to a user operation performed for the image display apparatus.

13. The image display apparatus according to claim 1, wherein
at least one of the range information and the area information is acquired according to a user operation performed for the image display apparatus.

14. The image display apparatus according to claim 1, wherein
at least one of the range information and the area information is input from an external apparatus to the image display apparatus.

15. A control method for an image display apparatus including a light-emitting unit which has a plurality of light-emitting areas respectively corresponding to a plurality of divided areas constituting an area on a screen, and a display unit configured to display an image on the screen by modulating light from the light-emitting unit based on image data, the control method comprising the steps of:
acquiring, for each of the plurality of divided areas, a brightness characteristic value of image data corresponding to the divided area, from input image data;
acquiring range information indicating a second dynamic range, which is wider than a first dynamic range determined in advance;
acquiring area information indicating a specific area, which is an image area where display is performed in the second dynamic range;
detecting a correspondence divided area, which is a divided area corresponding to the specific area, from the plurality of divided areas based on the area information; and
performing individual control of emission brightness of each light-emitting area and correction of the input image data, based on the brightness characteristic value of each divided area, the range information and the detection result of the correspondence divided area, so that display in the first dynamic range is performed in a non-correspondence divided area, which is a divided area other than the correspondence divided area, and display in the second dynamic range is performed in the correspondence divided area.

16. An image display apparatus comprising:
a light-emitting unit which has a plurality of light-emitting areas respectively corresponding to a plurality of divided areas constituting an area on a screen;
a display unit configured to display an image on the screen by modulating light from the light-emitting unit based on the image data;
a characteristic value acquisition unit configured to acquire, for each of the plurality of divided areas, a brightness characteristic value of image data corresponding to the divided area, from input image data;
an information acquisition unit configured to acquire range information indicating a second dynamic range, which is wider than a first dynamic range determined in advance;
a detection unit configured to detect, as a specific area, a divided area that includes a pixel having the second dynamic range, from the plurality of divided areas based on the brightness characteristic value of each divided area;
a combining unit configured to, so that the detection result of the specific area is displayed as a graphic image, combine graphic image data indicating the graphic image;
a user interface unit configured to accept an instruction from a user whether display in the second dynamic range is performed in the specific area, after the graphic image is displayed; and
a control unit configured to perform individual control of emission brightness of each light-emitting area and correction of the input image data, based on the brightness characteristic value of each divided area, the range information and the instruction from the user, so that display in the first dynamic range or the second dynamic range is performed in the specific area.

17. The image display apparatus according to claim 16, further comprising:
an estimation unit configured to estimate power to be used by the light-emitting unit; and
a determination unit configured to, in a case where there are a plurality of collecting specific areas each of which is an area constituted by one or more specific areas and the power estimated by the estimation unit is greater than a threshold, determine a priority of each of the collecting specific areas, wherein
in a case where the priority of each collecting specific area is determined, the combining unit, so that the detection result of the specific area and the priority of each collecting specific area are displayed as a graphic image, combines graphic image data representing the graphic image.
